(19) United States
(12) Patent Application Publication
(10) Pub. No.: US 2023/0259988 A1
(43) Pub. Date: Aug. 17, 2023

(54) AUTOMATED PLATFORM-BASED DONATION MATCHING AND SECURITY

(71) Applicant: Block, Inc., San Francisco, CA (US)

(72) Inventors: Seth Friedman, Brooklyn, NY (US); Samihah Azim, San Francisco, CA (US); Justin Williams, Brooklyn, NY (US); Terrill Dent, Waterloo (CA)

(21) Appl. No.: 17/673,434

(22) Filed: Feb. 16, 2022

(51) Int. Cl. G06Q 30/02; G06Q 20/32

(52) U.S. Cl. CPC G06Q 30/0279; G06Q 20/3223

(57) ABSTRACT

Techniques described herein are directed to automated platform-based donation matching and security. An interactive element with data embedded therein is generated and, in response to an interaction with the interactive element, a request to transfer funds from an account of a user to another account associated with a group of one or more users is generated. When the request is received, at least one matching sponsor is identified from context data. A payment service facilitates a transfer of funds from the account of the user to a holding account of a payment service, and the payment service facilitates a transfer of additional funds from an account of the at least one matching sponsor to the holding account. Once a condition has been satisfied, the payment service transfers the funds and the additional funds from the holding account to an account associated with the group of one or more users.

### TECHNICAL FIELD

Applications, which are downloadable and executable on user devices, enable users to interact with other users. Such applications are provided by service providers and utilize one or more network connections to transmit data among and between user devices to facilitate such interactions.

### BRIEF DESCRIPTION OF THE DRAWINGS

Features of the present disclosure, its nature and various advantages, will be more apparent upon consideration of the following detailed description, taken in conjunction with the accompanying drawings. The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 is an example environment for automated platform-based donation matching and security, according to an embodiment described herein.

FIG. 2 is an example user interface displayed on an example user device, where the user interface is configured to present details associated with a fundraising event and to receive user input associated with the fundraising event, according to an embodiment described herein.

FIG. 3 is an example user interface displayed on an example user device, where the user interface is configured to present a social media application including an interactive element associated with a fundraising event and to receive user input that causes a payment application to be surfaced, according to an embodiment described herein.

FIG. 4 is an example user interface displayed on an example user device, where the user interface is configured to present functionality for making a donation to a fundraising event, according to an embodiment described herein.

FIG. 5 is an example user interface displayed on an example user device, where the user interface is configured to present functionality for sharing donation-related information associated with a fundraising event, according to an embodiment described herein.

FIG. 6 is an example user interface displayed on an example user device, where the user interface is configured to present information indicating that a payment service has authenticated a donation or a matching donation associated with a fundraising event, according to an embodiment described herein.

FIG. 7 is a sequence diagram showing an example process for making a donation and a matching donation to a fundraising event, according to an embodiment described herein.

FIG. 8 is a conceptual diagram showing components of a system utilized for identifying a matching sponsor associated with a fundraising event, according to an embodiment described herein.

FIG. 9 is a conceptual diagram showing components of a system utilized for determining one or more groups or fundraising events to associate with a user profile, according to an embodiment described herein.

FIG. 10 is an example user interface displayed on an example user device, where the user interface is configured to present functionality to allow for a matching donation to be made to a previous matching donation, according to an embodiment described herein.

FIG. 11 is a flow diagram of an example process for generating one or more actionable recommendations associated with a fundraising event, according to an embodiment described herein.

FIG. 12 is a flow diagram of an example process for utilizing tax-based functionality in association with a fundraising event, according to an embodiment described herein.

FIG. 13 is a flow diagram of an example process for determining whether a match limit has been met for a matching sponsor donation, according to an embodiment described herein.

FIG. 14 is a flow diagram of an example process for automated platform-based donation matching and security, according to an embodiment described herein.

FIG. 15 is a flow diagram of an example process for the generation and training of machine learning models to perform one or more of the processes described herein, according to an embodiment described herein.

FIG. 16 is an example environment with user devices, merchant devices, a payment service, and/or other systems that may be involved in a transaction, such as by utilizing the payment application as configured herein, according to an embodiment described herein.

FIG. 17 is an example environment illustrating usage of the payment application, such as described herein, according to an embodiment described herein.

FIG. 18 is an example of datastore(s) that can be associated with servers of the payment service, according to an embodiment described herein.

FIG. 19 is an example environment wherein the payment service environment of FIG. 16 and the environment from FIG. 17 can be integrated to enable payments at the point-of-sale using assets associated with user accounts in the peer-to-peer environment of FIG. 17, according to an embodiment described herein.

FIG. 20 is an illustrative block diagram illustrating a system for performing techniques described herein, according to an embodiment described herein.

### DETAILED DESCRIPTION

Techniques described herein are directed to, among other things, automated platform-based donation matching and security. In an example, techniques described herein enable the configuration of rules and conditions associated with payment transfers between accounts of a payment service. In an example, a “matching campaign” can be configured by generating rule(s) associated with triggering event(s) that cause funds associated with an account of an entity (e.g., the payment service, a group of users of the payment service, an individual user) to be transferred to another account, for example, associated with a fundraising event. Multiple matching campaigns can be stored by the payment service, and the payment service can monitor transactions associated with the payment service to determine, automatically and in real-time or near-real-time, when a particular matching campaign is applicable to a particular donation to a fundraising event. Such a determination can be made using machine-learning models, based at least in part on context data associated with the particular transaction. When a particular matching campaign is determined to be applicable to a particular donation, the payment service can facilitate transfers of funds from two or more user accounts to another account. That is, a single transaction (e.g., donation) can trigger two or more transactions (e.g., donations) such that funds can be transferred from multiple sources into a single recipient account.

As described above, techniques described herein relate to the use of a platform that intelligently recommends matching campaigns for donations associated with fundraising events and seamlessly facilitates movement of donation funds between parties. It should be understood that fundraising events, as described herein, may be associated with the donation of funds to a given charitable cause or any other accumulation of funds. As described herein, movement of funds can be effectuated using a ledger system associated with the payment service. In some examples, funds associated with recipient accounts can be subject to condition(s) on access to such funds. In such examples, the payment service can monitor states associated with such recipient accounts to determine when such condition(s) have been satisfied. Based at least in part on a determination that condition(s) associated with a particular recipient account have been satisfied, the payment service can enable access to associated funds. That is, techniques described herein relate to real-time or near-real-time monitoring of transactions to determine compliance with rule(s) or condition(s) to facilitate donation matching and security.

In an example, a fundraising event, which can be any event associated with aggregating or otherwise accumulating funds for one or more users of a group of users, may be initiated by any user of a payment application associated with a payment service. User input may be received via the payment application indicating information associated with the fundraising event, for example, the organizer of the fundraising event, the sponsor if any, details on the cause at issue, etc. Utilizing this information, the payment service may generate an interactive element that may be configured to be shared and displayed internally, within the payment application, and externally, such as on one or more third-party messaging applications, email applications, social media applications, forum applications, or the like. In some examples, the interactive element can have data embedded therein to trigger, in response to an interaction with the interactive element, a request to transfer funds from an account of a user to an account associated with a beneficiary of the fundraising event. In some examples, the interactive element may be selected by other users to cause display of functionality associated with the fundraising event on a user device. It should be understood that the interactive element may be shared in a message, such as in a peer-to-peer message, a social media post, an in-application notification, or the like, or the interactive element may be integrated into a message.

In some examples, the interactive element may be a link, including a deep link, a quick reference (QR) code, or any other selectable element. The functionality of the interactive element may be particularly robust and may update on-the-fly to provide potential donors with real-time or near-real-time information about the fundraising event. Such information may include progress toward a fundraising goal, an up-to-date number of donations and shares, details about the beneficiary, details about the organizer, indicators of whether the entities involved in the fundraising event are predesignated as trustworthy, etc. It should also be noted that when a user that selects the interactive element is not associated with the payment application on their user device, selection of the interactive element may cause an onboarding process to initiate for associating the user with the payment application, including causing the payment application download on the user device and for account creation to be initiated. Alternatively or additionally, the interactive element can be modified depending on the platform (e.g., the payment service) where it was generated, the platform where it is being shared or displayed (e.g., a social network or a fundraising platform), or the platform where it is being sent for receiving donations (e.g., a text messaging platform). For example, the interactive element may include attributes of the platform(s) to allow such modification. In this manner, the interactive element conforms to the technical specifications of the platform.

With respect to a given fundraising event, a user may select functionality that initiates a donation request and may go through an authentication and confirmation process to make the donation. For example, the user may provide user input on the amount of the donation and perform an authentication step, such as biometric authentication on the user device, to effectuate the donation. The payment application may present verification that the donation was made and provide functionality to allow the user to share an indication of the donation via one or more digital platforms, such as via a message, a social media post, etc. In some examples, verification of the donation can be presented as a “badge” or graphic associated with a user profile of the user on the payment service, such that when other users view the user's profile, the user profile can be “decorated” with indications of which fundraisers the user has donated to or otherwise participated in.

When a donation is made, the payment service may withdraw an amount of funds from a user account of the user and deposit the amount of funds in a holding account associated with the payment service. The amount of funds may remain in the holding account until one or more conditions associated with the fundraising event are satisfied, such as receipt of funds from sponsors, satisfying a fundraising amount threshold, satisfying a number of donations, etc. In addition to the funds from the user, matching sponsor funds may also be collected from one or more matching sponsors. To do so, at least one matching sponsor may be identified for the donation at issue. Identification may be based on context data, such as historical data associated with a group of users for the fundraising event, historical data associated with the beneficiary, geographic data, sponsor preferences, fundraising event subject matter, transaction data associated with the user or the potential sponsor, contacts data associated with the user, social relationship data, user preferences of the donor, metadata tag data, or other inputs, for example. One or more machine learning models may be generated and trained for the purpose of identifying matching sponsors, as described more fully below. Once identified, additional funds may be withdrawn from an account of the matching sponsor when conditions are met that allow for automatic withdrawal of such additional funds. The additional funds may be deposited into the holding account as described above. Once conditions of the fundraising event have been satisfied, the payment service may withdraw the funds and the additional funds from the holding account and deposit those funds in a beneficiary account. Proof of this deposit may be generated and displayed in association with the fundraising event.

Additionally, one or more groups may be generated in association with a given fundraising event, or in a manner that is unrelated to a fundraising event. The groups may be generated based on one or more attributes associated with the fundraising event or details associated with users of the payment service. Some factors may include group historical data indicating prior groups that users have been associated with, beneficiary historical data, geographic data, sponsor identifiers, fundraising event subject matter, transaction data, contacts data, social relationship data, user preferences, metadata tag data, and other inputs. As with identifying matching sponsors, one or more machine learning models may be generated and trained to determine and recommend groups to users. In these and other examples, a user may be identified as a potential match for inclusion in a group (or for inclusion in a yet-to-be-generated group). A user interface may display functionality for viewing group recommendations as well as details associated with the actionable recommendation, such as a percentage match of the user to the group or to a given fundraising event. In this manner, techniques described herein enhance new and unexplored donation opportunities by leveraging the user connections in the payment service and/or third-party data such as social connections. Once a group is formed, the payment service can create these unique network connections (within the payment service or with third-party systems) among the group members to allow for seamless and real-time exchange of data, including funds. In examples, functionality may be made available to a group that is not necessarily available to an individual that is not associated with a group. Such functionality may include access to information associated with other group member donations, matching donations, prior fundraising events the group members have been associated with, etc. The functionality may also include communication functionality that allows members of the group to communicate securely with each other in the context of the fundraising event.

Techniques described herein are directed to, among other things, the generation and use of a system for digital fundraising events that intelligently recommends donors to donation campaigns, efficiently creates groups of donors and sponsors matching donation funds, and seamlessly facilitates the donation funds to move between such parties. Fundraising events typically attempt to garner donations by word of mouth, advertising campaigns, etc., and some of these fundraising events advertise that a predefined sponsor will match or otherwise donate when a donor makes individual donations are made. However, when potential donors go to make a donation, those donors do not receive a real-time confirmation of the matching donation, do not receive verification of their donation that can be easily shared to bolster participation in the fundraising event, do not have insight on how many other donors have participated and to what degree, etc. Additionally, these fundraising campaigns have matching sponsors that have been predesignated and that have signed up to be sponsors for the event, often times a single matching sponsor that matches whatever donations a donor may make. That is, the functionality enabled by the payment application and payment service enable digital fundraising events that offer more security and less friction than existing fundraising events. As described more fully above and below, the shortcomings described herein of typical fundraising campaigns are dispelled by the on-the-fly matching sponsor determinations described in this disclosure, along with the ability to generate targeted user groups, targeted donation recommendations, and to facilitate multiple donation-based transactions in real-time or near-real-time.

Additional functionality performed by the payment application or payment service to make digital fundraising events more secure and successful may include presenting functionality for users to match matching donations, functionality for the automated generation of tax-related documentation for tax filings associated with donations, generation of actionable recommendations associated with fundraising events, performance of preference checks associated with matching sponsors, and other functionality as described herein. Such additional functionalities are availed by the integration of fundraising events with the payment service. The functionality may be provided by way of one or more application programming interfaces that configure the payment service to communicate data associated with fundraising events to other services and system in a secure manner. Details on how the payment service performs the functionality notes above are provided below.

In association with the operations described above, with the proliferation of digital platforms for sharing information and for performing transactions, there is a computer-centric problem of integrating functionality of disparate digital platforms in a way that promotes fundraising purposes in a secure manner. To start, success of a fundraising event typically depends on whether appropriate potential donors are notified of the fundraising event and whether a sufficient number of potential donors are notified. However, integration of and ability to share information across various digital platforms is difficult to effectuate and manage. Additionally, in a digital environment where entity identity is not easily confirmed, trust from potential donors that a donation will ultimately be provided to the stated beneficiary without a nefarious actor interfering is much more prevalent than outside of a computer-centric environment. Furthermore, as any user with the necessary abilities can generate any fundraising campaign on many digital platforms, a potential user may be flooded with opportunities to participate in fundraising activities but may not have any insight on which fundraising events are most tailored to the given user. To solve these and other computer-centric problems, the techniques and systems described herein utilize computer-centric solutions associated with a secure payment application and a payment service.

For example, the payment service may generate novel data representing an interactive element associated with a fundraising event. The interactive element may have data embedded therein to trigger a request to transfer funds when the interactive element is selected. Additionally, the interactive element may be configured to be shareable across digital platforms, including within the payment application and with multiple social media platforms in a manner that, when the interactive element is selected in another platform, the payment application is caused to move to a foreground of a user device to display time sensitive information associated with the fundraising event. On the fly generation of specific interactive elements and the shareability of such interactive elements across multiple, disparate digital platforms alleviates the computer-centric problem of cross-platform integration for digital fundraising events. The on-the-fly generation of these interactive elements involves computer-centric processes and the generation of new data in a computer environment. This offers technical improvements to conventional technology associated with fundraising events.

In addition to the above, the computer-centric solutions described herein identify a matching sponsor for a particular donation in real-time or near-real-time. To do so, specifically generated and trained machine learning models are utilized to take in, as input, disparate data associated with potential sponsors, donors, beneficiaries, etc. to determine which fundraisers are likely to be relevant to a matching sponsor and to identify donations that are candidates for a donation match. Such input can be referred to as “context data” and can be used for on-the-fly matching of sponsors to donations. This on-the-fly matching sponsor identification performed for each of potentially thousands of donations for a given fundraising event provides improvements to how fundraising events are able to be managed across platforms. As such, techniques described herein provide improvements to online, digital environments for fundraising events across multiple digital platforms. In examples, the payment service is configured to track transactions associated with fundraising events as well as user groups, user networks and/or network graphs, and interactions with other payment systems. This tracking may allow for more targeted donation recommendations, matching sponsor identification, group recommendations, etc.

Additionally, in examples, a donation may be made based at least in part on another donation being made. This may be referred to as “stack matching.” Stack matching may be performed automatically and without user input as described here. For example, where user preferences indicate that a matching donation is to be withdrawn when certain criteria are met, the stack matching may be performed by the payment service. For example, the criteria may be that a given user has made a donation, a given matching sponsor has made a donation, a certain number of matches have been made for a given donation, etc. In other examples, an indication of a matching donation may be displayed with functionality that allows another user to match that matching donation.

Additionally, generation and display of up-to-date “verification signals” in association with a fundraising event may be essential to fundraising event success. For example, static icons or other visual identifiers may be generated and displayed as soon as a donation is made, a matching donation is made, an interactive element is shared, a user joins the fundraising event, a goal of the fundraising event is satisfied, etc. In some examples, visual identifiers can be dynamic such that they change shape or form based on the attributes of the fundraising event (e.g., the entity to which the donation is made, the amount of donation, and so on). Further, visual identifiers can be tied to non-fungible tokens (NFTs), for example, if the donation is made via a digital currency, or if the donor has purchased NFTs from the fundraising event or otherwise available NFTs. Such verification signals that indicate certain actions are being taken in association with the digital fundraising event and after a certain event is complete (e.g., fundraising event), enable a robust system that shows potential donors that the fundraising event is secure and the current state of the fundraising event when a donation is made. This state tracking and provisioning of real-time verification signals enhances existing fundraising technology by providing more security than what is conventionally available.

Furthermore, the techniques described herein include the generation and training of machine learning models to, among other things, generate time sensitive actionable recommendations associated with fundraising events, identify matching sponsors, generate actionable recommendations associated with user groups, etc. The use of specifically trained machine learning models grounds the techniques described herein in a computer-centric environment and produces results that offer improvements over conventional technologies. The models may be trained again and again over time, each time learning new parameters or updating parameter weighting to make the results of those models more accurate, more timely, etc.

It should be noted that the exchange of data and/or information as described herein may be performed where a user has provided consent for the exchange of such information. For example, upon setup of devices and/or initiation of applications, a user may be provided with the opportunity to opt in and/or opt out of data exchanges between devices and/or for performance of the functionalities described herein. Additionally, when one of the devices is associated with a first user account and another of the devices is associated with a second user account, user consent may be obtained before performing some, any, or all of the operations and/or processes described herein. Additionally, the operations performed by the components of the systems described herein may be performed where a user has provided consent for performance of the operations.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

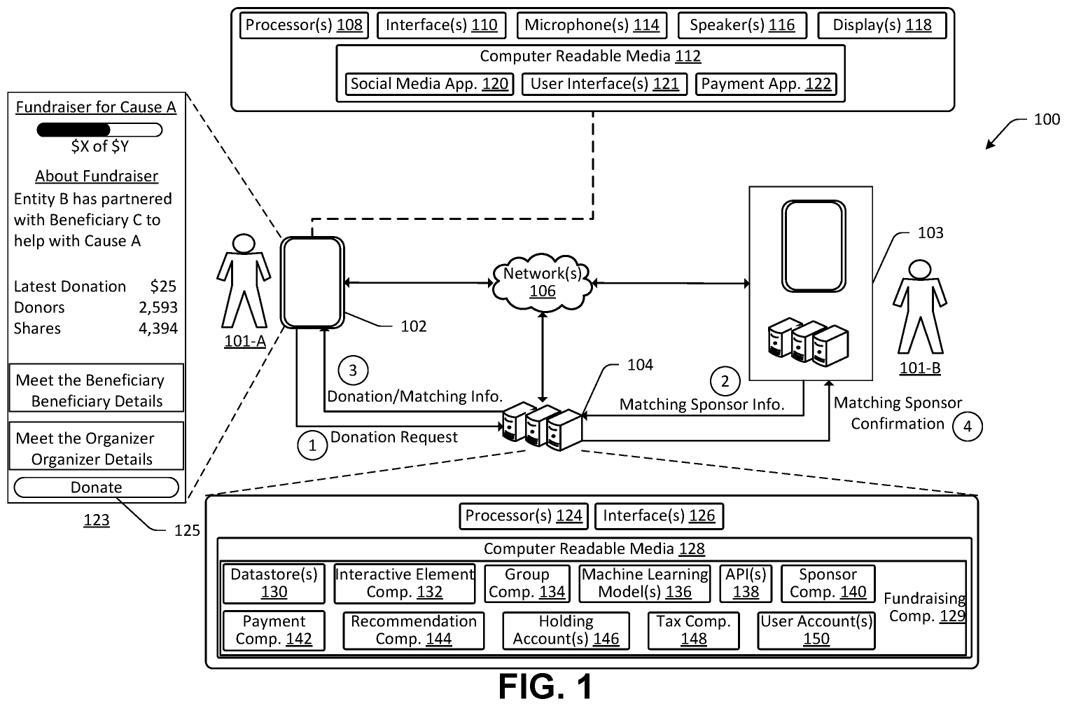

FIG. 1 is an example environment 100 for automated platform-based donation matching and security, according to an embodiment described herein. The environment 100 of FIG. 1 may include a user 101-A associated with a user device 102, a sponsor 101-B, or “matching sponsor,” associated with a sponsor device 103, and a payment service 104, which can communicate via network(s) 106. A user 101-A can be any donor that donates to a fundraising event and a sponsor 101-B may be any user that may match at least a portion or fraction of the funds donated by the user 101-A. In some examples, a sponsor may initiate the request that a user then donates to and the sponsor subsequently matches to while in other examples, a user may initiate the request that a sponsor matches.

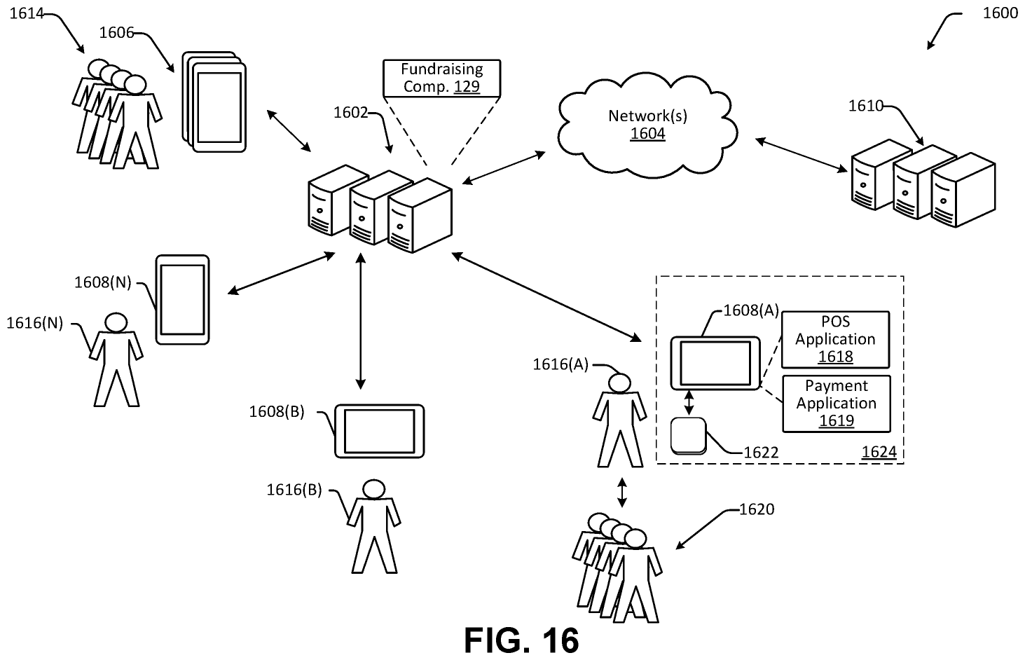

Each of the devices can comprise one or more computing devices. Additional details associated with the user device 102, the sponsor device 103, the payment service 104, and the network(s) 106 are described below with reference to FIGS. 16-20.

The user device 102 may include one or more components such as one or more processors 108, one or more network interfaces 110, computer-readable media (CRM) 112, one or more microphones 114, one or more speakers 116, and/or one or more displays 118. The microphones 114 may be configured to receive audio input from the environment 100 and to generate corresponding audio data, which may be utilized as discussed herein. The speakers 116 may be configured to output audio, such as audio associated with a given fundraising event. The displays 118 may be configured to present graphical user interfaces. In some examples, the displays 118 can output images, videos, or the like via such graphical user interfaces.

The sponsor device 103 may include the same or similar components as the user device 102 and may perform the same or similar functions, albeit from the perspective of a matching sponsor. A “matching sponsor,” as used herein, can correspond to an entity that has agreed to match or otherwise perform an action in association with another transaction. In some examples, the entity can be another user, a group of users, the payment service, or the like. In some examples, a “match” can correspond to a transfer of funds in a same amount as another transfer of funds or an amount determined based on another transfer of funds. In some examples, a matching sponsor can perform an action in association with a transfer of funds, such as providing an incentive, marketing the fundraising event, sharing the fundraising event on a social media platform, making an appearance, “liking” a fundraising event, or the like. In some examples, matches can be conditioned on one or more rules, such as particular fundraising events, particular causes (e.g., social justice, animal support, climate change, education, etc.), particular individuals, particular geographic locations, etc.

The user 101-A and sponsor 101-B can connect with each other, via their respective devices, in various scenarios. In a first example scenario, the user 101-A and sponsor 101-B can connect with each other in a peer-to-peer context, e.g., while the user 101-A and sponsor 101-B can send and receive funds and the sponsor 101-B has, in parallel, donated to a specific fundraising event. In a second example scenario, the user 101-A and sponsor 101-B can share music with one another. In a third example scenario, the user-110A and sponsor 101-B can exchange goods or services with each other. Additional or alternative scenarios can be imagined. It should be understood that a relationship between a user 101-A and a sponsor 101-B can be any relationship where the user makes an initial donation and a sponsor matches that initial donation or otherwise performs an action based on the initial donation being made.

The CRM 112 may include one or more applications or other components. For example, the one or more applications or other components can include a social media application 120, one or more user interface(s) 121, and a payment application 122. For the purpose of this disclosure, the social media application 120 may include any application residing on the user device 102 or available to the user device 102 that may allow a user to share content to other users. A user interface 121 can be included in the payment application 122 as an interstitial, widget, or pop-up display. The CRM 112 can include additional or alternative applications such as a music streaming application, a messaging application, an email application, a forum application, or the like. In some examples, the applications can be provided by a same service provider (e.g., the payment service) or different service providers, such as the payment service and one or more third-party service providers.

The applications or other components may be configured to execute in the foreground and background of the user device 102. For example, the payment application 122 may be configured to execute in the foreground when a user is actively engaged in one or more of the functionalities of the payment application 122. In other examples, the payment application 122 may be configured to execute in the background when a user is not actively engaged in one or more of the functionalities, but the payment application 122 is still “open” and is capable of communicating with other applications on the user device 102 and/or with payment service 104 associated with the payment application 122. For example, the social media application 120 may be executing in the foreground and an interaction with an interactive element as described in more detail herein may occur. The payment application 122, running in the background, may be caused to be displayed in the foreground in response to selection of the interactive element in the social media application 120. In some such examples, the payment application 122 can transition to the foreground to perform payment operations or can remain in the background and payment operations can be performed without the payment application 122 transitioning to the foreground. In other examples, the payment application 122 itself may be utilized to display interactive elements associated with fundraising events. Additionally, when sharing functionality is selected in the payment application 122, the social media application 120 may be caused to transition from running in the background to running in the foreground to allow for the sharing functionality to be performed. It should be understood that the user interfaces 121 described herein may include the social media application 120 and the payment application 122, and may include one or more other user interfaces as described herein. It should also be understood that the payment application 122 or the functionality associated therewith can be integrated into the social media application 120 or another third-party application.

The payment service 104, which can be associated with one or more computing devices, such as server computing devices, may include components such as one or more processors 124, one or more network interfaces 126, and/or CRM 128. The CRM 128 may include one or more components such as, for example, a fundraising component 129 that includes datastore(s) 130, an interactive element component 132, a group component 134, one or more machine learning models 136, one or more application programming interfaces (APIs) 138, a sponsor component 140, a payment component 142, a recommendation component 144, one or more holding accounts 146, a tax component 148, and one or more user accounts 150. These components will be described below by way of example.

In at least one example, the payment service 104 can expose functionality and/or services via the one or more APIs 138, thereby enabling functionality and/or services described herein to be integrated into various functional components of the environment 100. The API(s) 138, which can be associated with the payment service 104, can expose functionality described herein and/or avail payment services to various functional components associated with the environment 100. At least one of the API(s) 138 can be a private API, thereby availing services and/or functionalities to functional components (e.g., applications, etc.) that are developed internally (e.g., by developers associated with the payment service). At least one of the API(s) 138 can be an open or public API, which is a publicly available API that provides third-party developers (e.g., social media platforms described herein) with programmatic access to a proprietary software application or web service of the payment service. That is, the open or public API(s) can enable functionality and/or services of the payment service to be integrated into one or more applications. The API(s) 138 can include sets of requirements that govern how applications, or other functional components, can interact with one another.

In some examples, the payment service 104 can provide third-party entities with a software developer kit (“SDK”) that may utilize functionality exposed by the API(s) 138. The SDK can include software development tools that allow a third-party developer (i.e., a developer that is separate from the payment service) to include functionality and/or avail services as descried herein. The SDK and/or the API(s) 138 may include one or more libraries, programming code, executables, other utilities, and documentation that allows a developer to directly include functionality and/or avail services described herein within an application.

The datastore(s) 130 can store, among other types of data, user profiles. For instance, a user profile of the user can store payment data associated with payment instrument(s) or user account(s) of a user. In some examples, an account maintained by the payment service 104 on behalf of the user can be mapped to, or otherwise associated with, the user profile. Such an account can be associated with a stored balance maintained by the payment service 104. In some examples, funds associated with the stored balance can be received from peer-to-peer payment transactions (e.g., payment transactions between users), deposits from employers, transfers from external accounts of the user, and so on. In some examples, a user profile can indicate multiple user accounts or stored balances associated with a user profile, which can be associated with different assets, such as stocks, cryptocurrency, non-fungible tokens, or the like. In some examples, a user profile can include historical group data, geographic data, sponsor preferences, subject matter preferences, transaction data, contacts data, social relationship data, user preferences, metadata tag data, and other information associated with participation in fundraising events. Additional details associated with data that can be stored in association with user profiles are provided below.

For the purpose of this discussion, a “fundraising event,” can be associated with any aggregation or accumulation of funds, which can be associated with a group of one or more users. In some examples, a fundraising event can be associated with a beneficiary, which can be a non-profit or not-for-profit organization. However, in some examples, a fundraising event can correspond to a gift to be provided to a user from a group of one or more other users (e.g., a wedding gift, a baby gift, a graduation gift, etc.), a savings account for a group of one or more users to make a purchase, such as a vacation, to pay bills, to purchase stocks or cryptocurrency, or the like. In some examples, a fundraising event can be associated with a metadata tag representative of the fundraising event. In some examples, the metadata tag can be used in lieu of payment data to make a payment to the fundraising event. In some examples, a fundraising event can be associated with a title, organizer(s), a fundraising goal, or the like. In some examples, fundraising events can be represented by data objects that are stored in the datastore(s) 130. Such data objects can be used for tracking states associated with such fundraising events. In some examples, such data objects can be associated with one or more balances from which funds can be transferred or into which funds can be received using the ledger system as described herein. In some examples, fundraising events can be associated with “pages,” that can be presented via user interfaces of user devices, for example, via the payment application 122. In some examples, such “pages” can provide information about the fundraising event and can include one or more interactive elements to initiate a donation to the fundraising event, share interactive elements with other users (e.g., via the payment application 122 or third-party services), or the like. Additional details are provided below.

The interactive element component 132 may be configured to generate interactive elements associated with fundraising events. For example, a fundraising event may be initiated by any user of the payment application 122 associated with the payment service 104. User input may be received via the payment application 122 for the organizer of the event, the sponsor if any, details on the cause at issue, etc. Utilizing this information, the interactive element component 132 may generate an interactive element that may be configured to be shared and displayed in the payment application 122 and outside of the payment application 122, such as on one or more social media applications 120. The interactive element can correspond to a link, a deep link, a bar code, a QR code, or any other element that is capable of interaction. In some examples, the interactive element can have data embedded therein to trigger a transfer of funds, for example, via a donation. Additionally, data object tracking or transaction state tracking may be performed as described herein. In these examples, the interactive element component 132 may generate one or more interactive elements based at least in part on data objects that are tracked or a given state of a transaction. For example, once a donation is made and thus a state of a transaction indicates that funds for the donation have been acquired, the interactive element component 132 may generate a “matching” interactive element for display as described herein.

In some examples, the interactive element may be selected by other users to cause display of functionality associated with the fundraising event on a user device 102. The functionality may be particularly robust and may update on-the-fly to provide potential donors with real-time information about the fundraising event. Such information may include progress toward a fundraising goal, up-to-date number of donations and shares, details about the beneficiary, details about the organizer, indicators of whether the entities involved in the fundraising event have been predesignated as trustworthy, etc. An example user interface 123 that shows the details of a fundraising event are presented in FIG. 1. Those details may include, for example, a title of the fundraising event, an indication of fundraising progress for the event, details about the fundraising event, a latest donation amount, a number of donations, a number of times the interactive element associated with the event has been shared, and other details associated with the fundraising event. Details about the beneficiary of the fundraising event and details about the organizer may also be provided. Further, functionality that allows for the initiation of a donation may also be provided, for example, via an interactive element 125 that is selectable to initiate a donation.

When user input data is received indicating a request to make a donation to the fundraising event (e.g., via an interaction with the interactive element 125), the payment component 142 may initiate a process of withdrawing funds from a user account 150 of the user at issue. That is, based at least in part on receiving input data indicating an interaction with the user interface element 125, the payment component 142 can determine that the user account 150 with which the interaction is associated intends to transfer funds, via a donation, to an account associated with the fundraising event. The interactive element 125 can have data embedded therein to indicate the account of the fundraising event. For example, the embedded data may cause the payment service 104 to determine an identifier of the fundraising event as well as accounts associated therewith, and particularly holding accounts for deposit of donation funds. Alternatively or additionally, the interactive element 125 can be modified depending on the platform (e.g., the payment service 104) where it was generated, the platform where it is being shared or displayed (e.g., a social network or a fundraising platform), or the platform where it is being sent for receiving donations (e.g., a text messaging platform). For example, the interactive element 125 may include attributes of the platform(s) to allow such modification. In this manner, the interactive element 125 conforms to the technical specifications of the platform. Additionally, the embedded data may direct the payment service 104 to the user interfaces 121 that are to be displayed or information associated with those user interface 121 specific to the fundraising event at issue. The user may provide input on the amount of the funds, and the payment component 142 may withdraw that amount of funds from the user account 150 and deposit the funds into the holding account 146. The funds may remain in the holding account 146 until one or more conditions are met. Those conditions may include, for example, a matching sponsor donation being made, a threshold number of donations to the fundraising event being made, a threshold number of interactive element shares being performed, a fundraising goal of the fundraising event being met, etc.

In some examples, donations can be made to the fundraising event via additional or alternative mechanisms. For example, a peer-to-peer payment may be made where the fundraising event is identified based on one or more metadata tags, such as hash tags. In other examples, a mention, comment, tag, or other digital association on a social media platform may be utilized to make donations to the fundraising event or to open the payment application 122 for facilitation of the donation. Some examples of this may include a mention in a message, a social media post, a forum posting, etc. It should be understood that any application or digital platform may be utilized in connection with the payment application 122 to facilitate a donation to a fundraising event. In these and other examples, data associated with the application being utilized by the user may be at least a portion of the context data as described herein for identifying a matching sponsor. In these examples, the data from the applications may be parsed to determine data types that are usable by the models described herein to identify matching sponsors. In addition to the above, users can configure the donations described herein as one-time payments to the beneficiary through the fundraising event. Additionally, the donations described herein may be made by recurring payments, round ups from other transactions (e.g., a purchase of a product not necessarily related to the fundraising event is made for $94.57, and the user may round up the purchase to, say, $100 with the difference being applied as a donation to the fundraising event), or as diversions from a direct deposit (e.g., user requests that a portion of a direct deposit be transferred to an account associated with the fundraising event). It should be understood that matching sponsor donations, along with the donations described herein, may also be made utilizing one or more of the transaction types described just above.

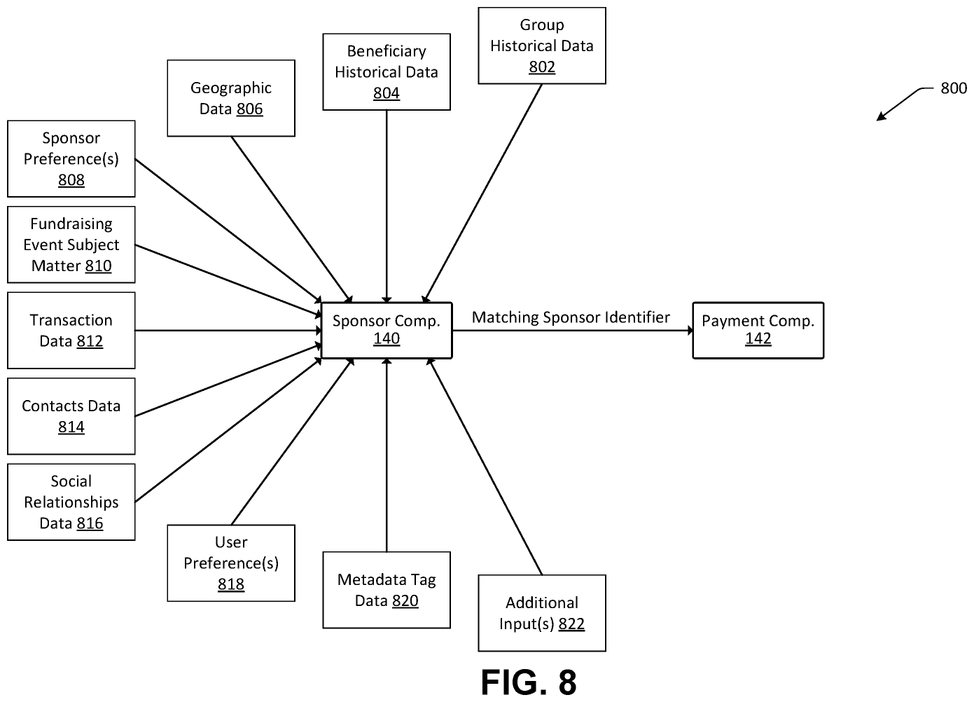

In addition to direct donations being made to the fundraising event, for example, by selection of the donation functionality in the payment application 122, matching sponsor donations may also be made. To do so, the sponsor component 140 may be configured to identify a matching sponsor for the fundraising event or for a specific donation to the fundraising event. For example, the sponsor component 140 may utilize one or more models (such as machine learning models 136) to determine one or more sponsors to make a matching donation. The models may be configured to utilize, as input, historical data associated with a group of users for the fundraising event, historical data associated with the beneficiary, geographic data, sponsor preferences, fundraising event subject matter, transaction data associated with the user or the potential sponsor, contacts data associated with the user, social relationship data, user preferences of the donor, metadata tag data, or other inputs, for example. Each of these input types, which can be referred to as “context data,” are described in more detail below with respect to FIG. 8. In general, the sponsor component 140 may utilize some or all of these inputs to identify one or more sponsors for providing a match sponsor donation. That is, the sponsor component 140 can identify one or more sponsors to which the specific donation or fundraising event may be relevant and may facilitate one or more match sponsor donations based at least in part on identifying such sponsor(s). In some examples, multiple sponsors can be identified thereby enabling “stack matching,” such that a single donation can trigger multiple match sponsor donations. Additional details are provided herein.

A non-limiting example of a process for identifying and confirming a matching sponsor is illustrated in FIG. 1. As shown in FIG. 1, at step 1, a donation request may be sent from the device 102 to make a donation to a fundraising event. To determine a matching sponsor for the donation, matching sponsor information may be retrieved from one or more potential sponsor devices 103 at step 2. Once a matching sponsor is identified and funds from the matching sponsor have been withdrawn from the matching sponsor account, at step 3, donation and matching sponsor information may be sent to the device 102 indicating that the donation and matching sponsor donation have been made. At step 4, confirmation of the matching sponsorship may be sent to the sponsor device 103. As described above, in some examples, matches can be determined automatically, without further input the users.

In an example, a given user may have donated $25 to a given fundraising event utilizing the functionality described herein. The sponsor component 140 may identify a given sponsor to match the $25 donation and may communicate with the sponsor device 103 associated with the sponsor to effectuate the matching sponsor donation. For example, particularly when sponsor preferences indicate, a notification of the matching sponsor donation may be presented on the sponsor device 103 and user input may be received to confirm that the donation should occur. In other examples where the matching sponsor donation is performed automatically or otherwise without user input, an indication of the donation may be presented on the sponsor device 103. It should be understood that the sponsor device 103 may be a personal device or may be a system of one or more devices.

In certain embodiments, the sponsor component 140 may determine that the sponsor is the payment service 104 itself. In other examples, the sponsor component 140 may determine that the sponsor is a member of a group associated with the fundraising event, or is an entity that is not a member of such a group. To that end, the group component 134 may be configured to generate, recommend, and maintain groups of users associated with a given fundraising event. For example, when a user participates in a fundraising event, a user profile for that user may be included in a group associated with the fundraising event. In other examples, an actionable recommendation to join a group associated with the fundraising event may be sent to user devices 102 and corresponding user profiles may be added to the group when requested to do so. The groups may be generated based on one or more factors associated with the fundraising event or details associated with users of the payment service 104. Some factors may include group historical data, beneficiary historical data, geographic data, sponsor identifiers, fundraising event subject matter, transaction data, contacts data, social relationship data, user preferences, metadata tag data, and other inputs. As with identifying matching sponsors, one or more machine learning models 136 may be generated and trained to determine and recommend groups to users. In these and other examples, a user may be identified as a potential match for inclusion in a group (or for inclusion in a yet-to-be-generated group). A user interface 121 may display functionality for viewing group recommendations as well as details associated with the actionable recommendation, such as a percentage match of the user to the group or to a given fundraising event.

Once a matching sponsor, whether from the group in question or otherwise, is identified, additional funds for the matching sponsor donation may be withdrawn by the payment component 142 and deposited into the holding account 146 in a similar manner as how the funds from the user are deposited. When the one or more conditions described herein are satisfied, the payment component 142 may deposit the funds from the user and the additional funds from the matching sponsor into a beneficiary account, which may be one of the user accounts 150. By so doing, the payment service 104 may facilitate potentially thousands of donations and potentially thousands of matching sponsor donations, all while providing functionality for the generation and sharing of interactive elements across platforms.

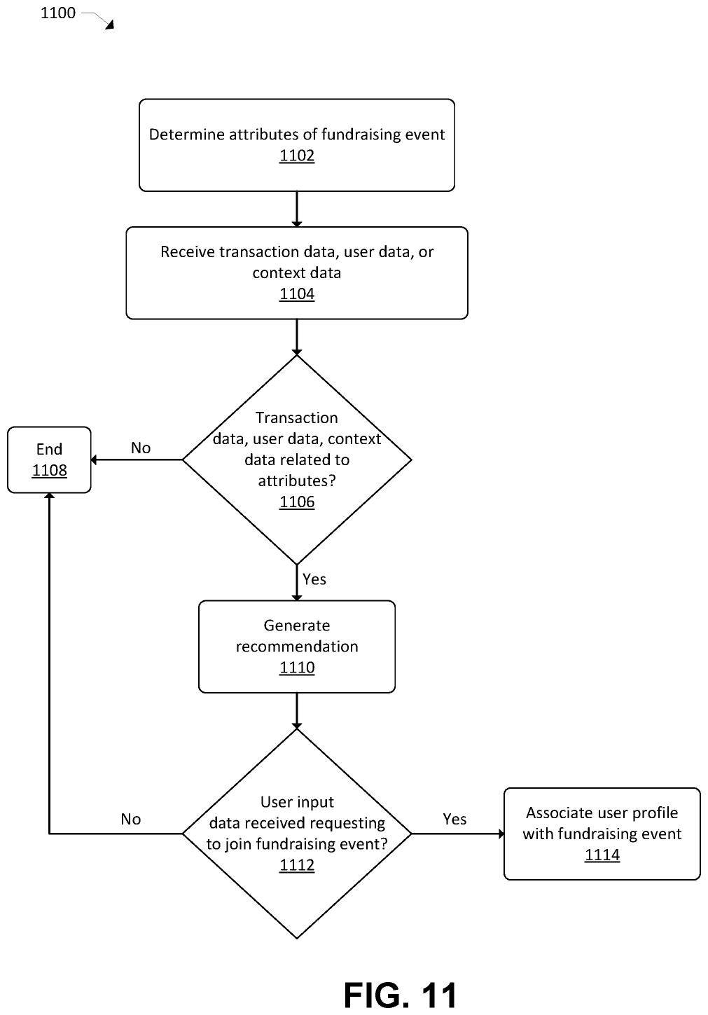

In addition to the above, the recommendation component 144 may be configured to generate and send one or more actionable recommendations to user devices 102 and sponsor devices 103. The actionable recommendations may be to join a group, join a fundraising event, make a donation, act as a matching sponsor, match a matching sponsor donation, etc. Additional details on the generation and use of recommendations is provided below with respect to FIG. 11.

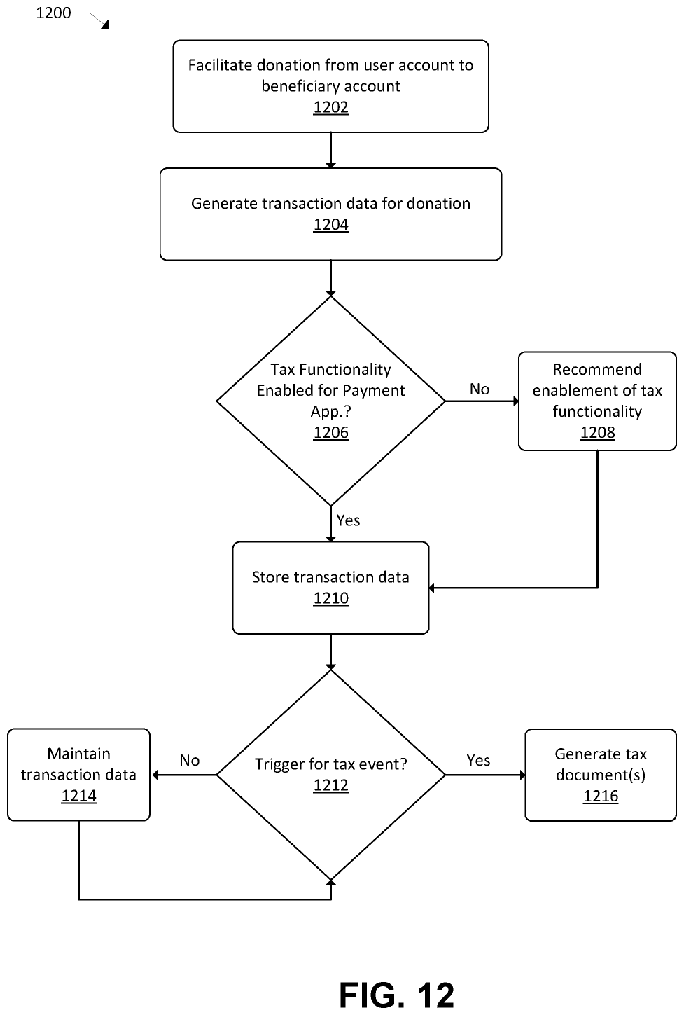

Furthermore, the tax component 148 may be configured to associate tax-based functionality of the payment service 104 with fundraising events. For example, when a user makes a donation and when a matching sponsor makes a donation, such a donation may have tax implications, such as for tax write-off purposes. Records of such donations should generally be maintained for audit purposes and for accurate recordkeeping. When the tax-based functionality of the payment service 104 is enabled, data indicating a given donation may be associated with a user profile of the user and saved in a database associated with the tax component 148. When a trigger event occurs, such as the receipt of user input or timing triggers, the tax component 148 may generate one or more tax documents associated with the donation. Such generation can occur automatically, without additional input from the user. Additionally, or alternatively, the tax component 148 may generate tax filing documents and submit those documents with the donation information included. Additional details on the use of the tax-based functionality of the tax component 148 is provided below with respect to FIG. 12.

In some implementations, the methods and systems described herein can be integrated with voice services (e.g. Amazon's ALEXA®, Apple's SIRI®, or Microsoft's CORTANA®) through specific API calls to such services. The present methods and systems can integrate with the “wake words” for invoking their respective voice service, ecommerce and fulfillment channels. For example, speaker recognition techniques may be utilized to determine user profiles associated with users that provide user utterances to user devices for performing one or more of the operations described herein.

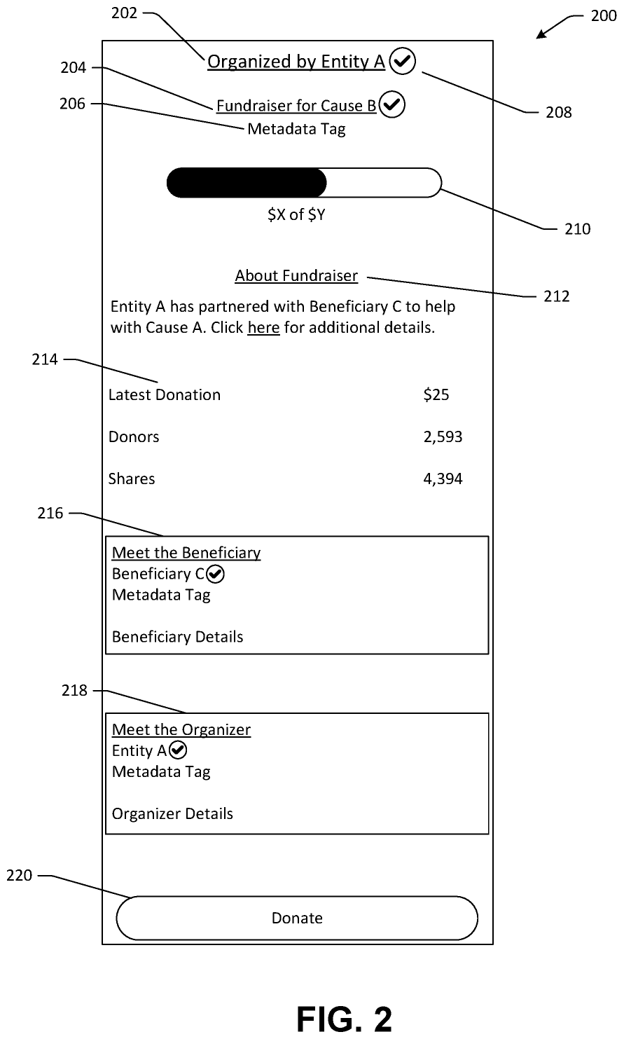

FIG. 2 is an example user interface 200 displayed on an example user device, where the user interface 200 is configured to present details associated with a fundraising event and to receive user input associated with the fundraising event, according to an embodiment described herein. The user interface 200 may be one of the user interfaces 121 described with respect to FIG. 1, and may be displayed utilizing the payment application 122 as described herein.

The user interface 200 may display information and functionality associated with a given fundraising event. For example, the user interface 200 may include an organizer indicator 202, which may provide identifying information about the organizer of the fundraising event. The user interface 200 may also include a beneficiary indicator 204, which may provide identifying information about the beneficiary of the fundraising event. Additionally, for the fundraising event at issue, a metadata tag 206 may be generated and displayed. For example, on certain social media platforms, metadata tags such as hashtags are generated and utilized to create associations and refer to accounts, posts, etc. For the payment application 122, metadata tags 206 may be generated for user profiles, accounts, and for events such as fundraising events. The metadata tag 206 for a given fundraising event may be displayed in the user interface 200 and may be utilized to identify the fundraising event across profiles of the payment application 122. In some examples, a metadata tag 206 can be used to identify a fundraising event or trigger a payment (e.g., donation thereto), wherein the metadata tag 206 can be used in lieu of payment data associated with the beneficiary.

The user interface 200 may also include verifier icons 208. The verifier icons 208 may provide an indication to viewers of the fundraising event that the entity associated with a given verifier icon 208 has been verified or otherwise authenticated by the payment service 104. For example, certain fundraising event organizers and beneficiaries may be legitimate in the sense that past transactions and historical data suggestion that the entity is not a nefarious actor. The payment service 104 may utilize the data available to it to determine whether the organizer, beneficiary, or any other entity associated with the fundraising event is associated with historical data that indicates whether the entity has previously engaged in activity that is deemed inappropriate by the payment service 104. Such activity may include, but is not limited to, inaccurate claiming of tax-exempt status, inaccurate details about the entity, lacking confirmation of account details, etc. When such data indicates the entity is verified, the verifier icon 208 may be caused to be displayed in association with the given entity. When not verified, no icon may be presented. In situations where the payment service 104 determines that the entity is likely a nefarious actor, a different icon indicating as much may be displayed.

Additionally, generation and display of up-to-date “verification signals” in association with a fundraising event may be essential to fundraising event success. For example, static icons or other visual identifiers may be generated and displayed as soon as a donation is made, a matching donation is made, an interactive element is shared, a user joins the fundraising event, a goal of the fundraising event is satisfied, etc. In some examples, visual identifiers can be dynamic such that they change shape or form based on the attributes of the fundraising event (e.g., the entity to which the donation is made, the amount of donation, and so on). Further, visual identifiers can be tied to NFTs, for example, if the donation is made via a digital currency, or if the donor has purchased NFTs from the fundraising event or otherwise available NFTs. Such verification signals that indicate certain actions are being taken in association with the digital fundraising event and after a certain event is complete (e.g., fundraising event), enable a robust system that shows potential donors that the fundraising event is secure and the current state of the fundraising event when a donation is made. This state tracking and provisioning of real-time verification signals enhances existing fundraising technology by providing more security than what is conventionally available.

The user interface 200 may also include a progress indicator 210, which may be configured to display a real time indication of how much money has been raised for the fundraising event and what the goal of the fundraising event is. This progress indicator 210 may be updated after some or each of the donations described herein to show a time-sensitive indication of how the fundraising event is progressing. The user interface 200 may also include fundraiser details 212, which may include text and images that provide details about the fundraising event. The fundraiser details 212 may be provided by the organizer of the fundraising event or may be determined by the payment service 104.

The user interface 200 may also include dynamic data 214 associated with the fundraising event. The examples of dynamic data 214 shown in FIG. 2 include a latest donation amount, a number of donations, and a number of shares of the fundraising event. It should be understood that the dynamic data 214 may include any information that changes as donations and matching donations are made, such as, for example, an average donation amount, a number of matching sponsors, a number of matches to matching donations, a number of group members, a number of groups, etc. Such dynamic data can be generated based at least in part on real-time or near-real-time monitoring of transactions associated with the payment service. The user interface 200 may also include beneficiary details 216 and organizer details 218. The beneficiary details 216 may provide additional information about the beneficiary as well as a metadata tag associated with the beneficiary. The organizer details 218 may provide additional information about the organizer as well as a metadata tag associated with the organizer.

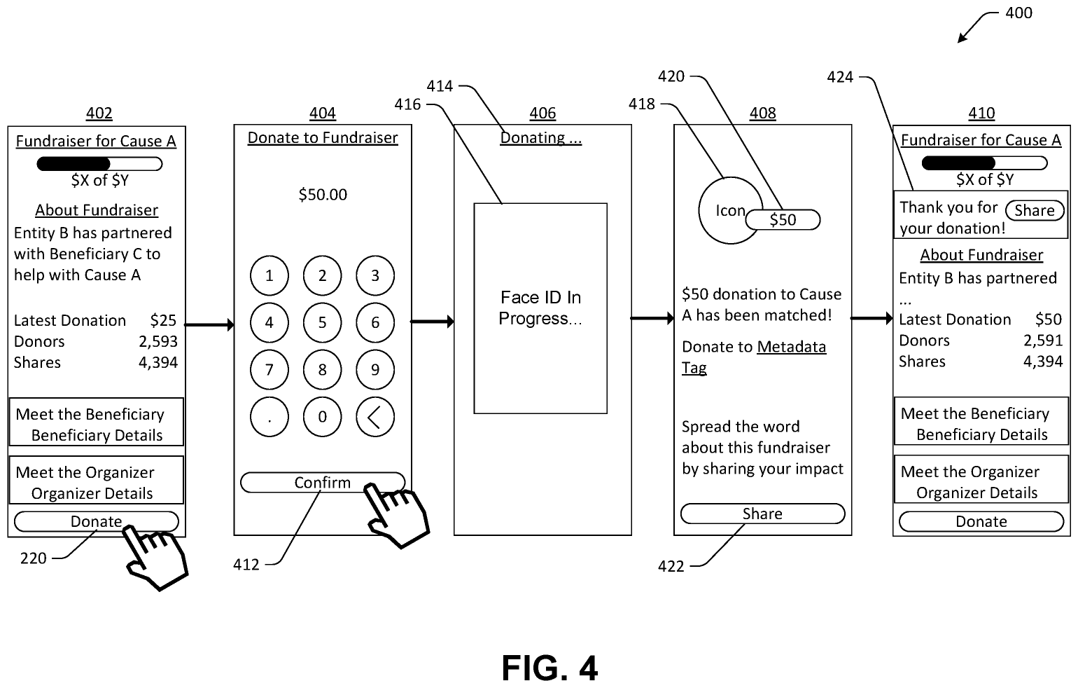

The user interface 200 may also include a donate element 220, which may be configured to be selected to initiate a process of donating to the fundraising event. Additional details on the process for donating is described below with respect to FIG. 4. In examples, the donate element 220 may be an interactive element, such as the interactive element 125 described with respect to FIG. 1. It should be understood that the donate element 220 may take one or more forms other than what is specifically shown in FIG. 2, such as a QR code, link, etc.

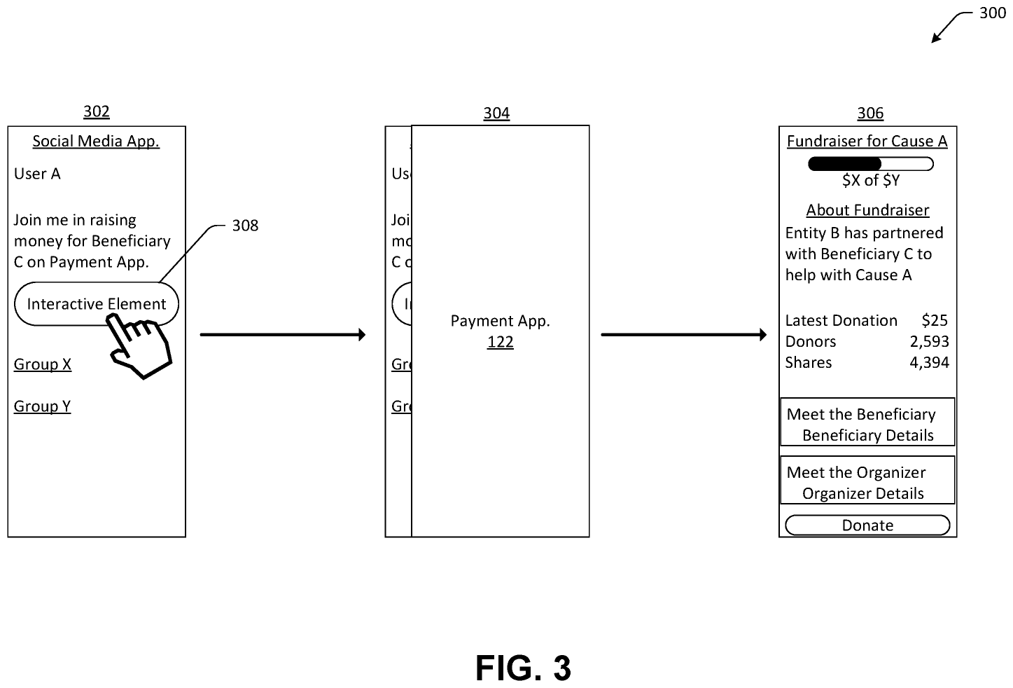

FIG. 3 is an example user interface 300 displayed on an example user device, where the user interface 300 is configured to present information associated with a social media application including an interactive element associated with a fundraising event and to receive user input that causes a payment application to be surfaced, according to an embodiment described herein. The user interface 300 may be one of the user interfaces 121 described with respect to FIG. 1. Progression of the operations performed in association with the user interface 300 are provided with respect to steps 302 through 306. It should be understood that while a social media application is shown in FIG. 3, the application can be any other application configured to present information to a user, such as a music streaming application, a meta verse application, etc.

At step 302, the user interface 300 may display information associated with a social media application, such as the social media application 120 described with respect to FIG. 1. While the displayed information may include many types of information associated with social media functionality, with respect to the present innovations, the user interface 300 may allow a user to post or otherwise provide information on a fundraising event. Part of the post may include a description of the fundraising event and a call to action for other users to join the fundraising event. Additionally, an interactive element 308 may be displayed in association with the post.

An interactive element component 132 of the payment service may be configured to generate interactive elements 308 associated with fundraising events. For example, a fundraising event may be initiated by any user of the payment application 122 associated with the payment service. User input may be received via the payment application 122 for the organizer of the event, the sponsor if any, details on the cause at issue, etc. Utilizing this information, the interactive element component 132 may generate an interactive element 308 that may be configured to be shared and displayed in the payment application 122 and outside of the payment application 122, such as on one or more social media applications 120. This interactive element 308 may be selected by other users to cause display of functionality associated with the fundraising event on a user device.

As shown in FIG. 3, when the interactive element is selected, at step 304, the social media application 120 may transition from running in the foreground of the user device to the background of the user device. Additionally, the payment application 122 may transition from running in the background of the user device to the foreground of the user device. In this example, the interactive element 308 may be a deep link element that not only causes the payment application 122 may be surfaced on the user device, but to navigate the user directly to a portion of the payment application 122 associated with the fundraising event for the interactive element, as opposed to simply bringing up a home or default page of the payment application 122. By doing so, a user may not need to navigate from the home or default page to where a donation is made, may not need to input user information, may not need to input authorization credentials, etc. In some examples, selection of the interactive element 308 may cause the donation to be made without any additional user input required. In some examples, instead of the payment application 122 being brought to the foreground of the device at issue, the donation may be made while the social media application 120 is still in the foreground, or functionality for downloading or otherwise accessing the payment application 122 may be brought to the foreground.

At step 306, the user interface 200 from FIG. 2 may be presented and user input may be received for initiating donations and displaying information associated with the fundraising event.

FIG. 4 is an example user interface 400 displayed on an example user device, where the user interface 400 is configured to present functionality for making a donation to a fundraising event, according to an embodiment described herein. The user interface 400 may be one of the user interfaces 121 described with respect to FIG. 1, and may be displayed utilizing the payment application 122 as described herein. Progression of the operations performed in association with the user interface 400 are provided with respect to steps 402 through 410.

At step 402, the user interface 200 from FIG. 2 may be presented and user input may be received for initiating donations and displaying information associated with the fundraising event. The user interface 200 may include some or all of the information described above with respect to FIG. 2. In the example in FIG. 4, a user may select a portion of a screen of the user device that corresponds to the donate element 220.

At step 404, based at least in part on receiving the selection of the donate element 220, functionality for inputting an amount of the donation may be presented. To do so, a number pad or any other input means may be displayed to allow the user to input a monetary amount to be donated. Once a user is satisfied with the entered amount of the donation, the user may select a confirmation element 412, which may indicate that the user wishes to finalize the donation in the amount provided. In some examples, the donation can be associated with a particular currency or asset (e.g., stock, cryptocurrency, or the like), which can be indicated in the user interface at step 404. In some examples, the payment service can perform a conversion between currencies or assets to facilitate the donation.

At step 406, a donation progress element 414 may be displayed. The donation progress element 414 may provide an indication to the user that the payment service is working on completing the donation. Additionally, an authentication element 416 may be displayed. The authentication element 416 may show a request for the user to provide some form of authentication prior to completing the donation. In the example of FIG. 4, the authentication element 416 requests that facial recognition be utilized to confirm that the user of the user device is in fact an authorized user of the user device. Other forms of authentication may also be provided, such as a request for a password, a request for other biometric information such as a fingerprint.

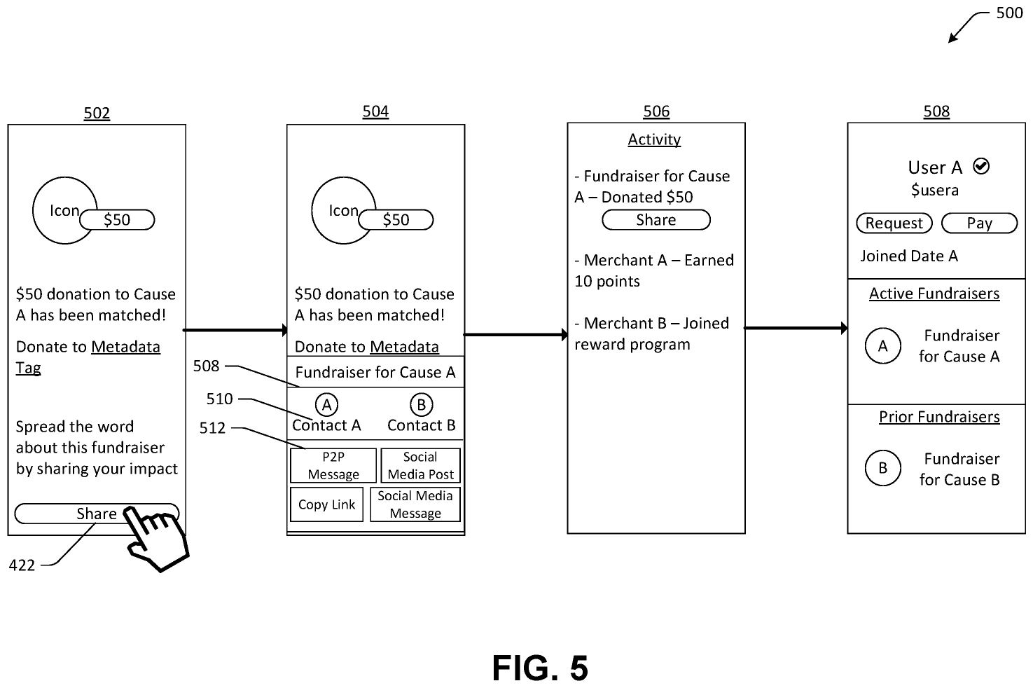

At step 408, once user authentication occurs and a payment component of the payment service withdraws the indicated funds from a user account of the user, confirmation of the donation may be presented to the user. The confirmation may include a fundraiser indicator 418, an amount indicator 420, and a sharing element 422, amongst other information. The fundraiser indicator 418 may be an icon or otherwise an image or text that provides a visual indication of the fundraising event to which the donation was made. The amount indicator 420 may provide a visual indication of the amount the payment service withdrew from the user account. The sharing element 422 may be configured to be selected to cause information associated with the donation to be shared on the payment application 122 and the social media application 120, among other sharing mediums. Additional details on sharing indications of donations is provided below with respect to FIG. 5.

At step 410, once the donation has been made, the user interface 200 that shows details of the fundraising event may be updated to reflect the donation. For example, a donation confirmation 424 may be displayed that shows that the donation from the user has been made. Additional details about the donation may also be displayed, such as whether a matching sponsor donation was made, functionality for sharing the donation, a thank you message, etc. In addition, the dynamic data associated with the fundraising event may be updated to reflect the donation, here showing that the latest donation was in the amount of $50 and the donation count being increased by one.

FIG. 5 is an example user interface 500 displayed on an example user device, where the user interface 500 is configured to present functionality for sharing donation-related information associated with a fundraising event, according to an embodiment described herein. The user interface 500 may be one of the user interfaces 121 described with respect to FIG. 1, and may be displayed utilizing the payment application 122 as described herein. Progression of the operations performed in association with the user interface 500 are provided with respect to steps 502 through 508.

At step 502, the user interface 400 as shown in step 408 of FIG. 4 may be displayed and a user may select the share element 422. This may indicate an intent to share information associated with the donation on the payment application 122 or the social media application 120, for example.

At step 504, the user interface 500 may cause an overlay 508 to be presented that provides options associated with sharing details of the donation that has been made. Those options may include contact indicators 510 and sharing options 512. The contact indicators 510 may include indicators of user profiles associated with the user, such as from a contacts list maintained by the user device, a “friends” or “followers” list maintained by a social media application 120, an email contacts index, and any other user profile dataset associated with the user or user device. The sharing options 512 may include options for which applications, platforms, or communication means are to be used to share details of the donation. It should be understood that the functionality described herein for sharing details of a donation may also be utilized to share the fundraising event itself, details about the fundraising event, interactive elements for accessing the fundraising event, user interaction with the fundraising event, etc. In these and other examples, a matching donation may be based at least in part on referrals to the fundraising event as made by users that share information about the event (e.g., more referrals amounts to a larger matching donation). This change to a matching donation may be made by the payment service or one or more users of the payment service. As shown in FIG. 5, the sharing options 512 may include a peer-to-peer (P2P) option, a social media post option, a copy link options, and a social media message option. It should be understood that any other means of communication may also be provided. With respect to the P2P option, a text messaging application or other P2P application may be caused to be engaged when this option is selected. A selectable link or other indicator of the donation may be automatically included in a message and the user may send the message along with, in some examples, additional text if desired. The social media post option may, when selected, cause the social media application 120 to engage and to start a new post with an indicator of the donation in it. The social media message option may, when selected, cause the social media application 120 to engage and start a new message with the indicator of the donation in it. The copy link option, when selected, may cause a uniform resource locator or other database locator to be copied and then pasted into a form for use by the user, such as in an email, in a text message, etc.

At step 506, an activity page may be presented or be selectable to show the donation at issue. The activity page may present activity associated with the user account at issue, and that activity may include donations to fundraising events, matching sponsor donations made by the user account, as well as non-fundraising information, such as payment information or other actions taken in association with the payment application. The share functionality described above may also be maintained in the activity page to share the fundraising event or an indication that the user has donated to the fundraising event. In addition to the above, one or more badges, links, or other elements may be generated that are associated with the donation at issue. These items may be shared across user profiles to show what individual users are involved and what functionalities of the payment application are being utilized by users.

At step 508, a user profile page may be displayed to show information associated with the user, and particularly information associated with active fundraising events and prior fundraising events that the user has participated in. The user profile page may include an identifier of the user, a metadata tag associated with the user, and functionality that is not necessarily linked to fundraising events, such as the ability to request payment from another user or to pay another user. Additionally, when a user is engaged with an active fundraising event, an indication of the active fundraising event may be displayed in the user profile page along with a “badge” or other visual indicator of the fundraising event. This type of active fundraising event indication may indicate that the user has joined a group associated with the fundraising event, has joined the fundraising event individually, has made a donation to the fundraising event, has made a matching sponsor donation to the fundraising event, etc. In examples, indications of the user's involvement in the fundraising event may be provided. Furthermore, when the user has participated in a prior fundraising event that is no longer active (e.g., is no longer accepting donations), indications of these prior fundraising events may be displayed in the user profile page. Again, these indications may include a badge associated with the fundraising event as well as indicators of the user's involvement in those events. The badges may be selectable to initiate sharing of the fundraising event, the badge, or other information associated with the fundraising event, such as a donation made by the user, with one or more other users. Also, it should be noted that while the user profile page described at step 508 is depicted as depending on operations associated with step 506, the user profile page may be displayed and utilized without the operations associated with steps 502-506 being performed.

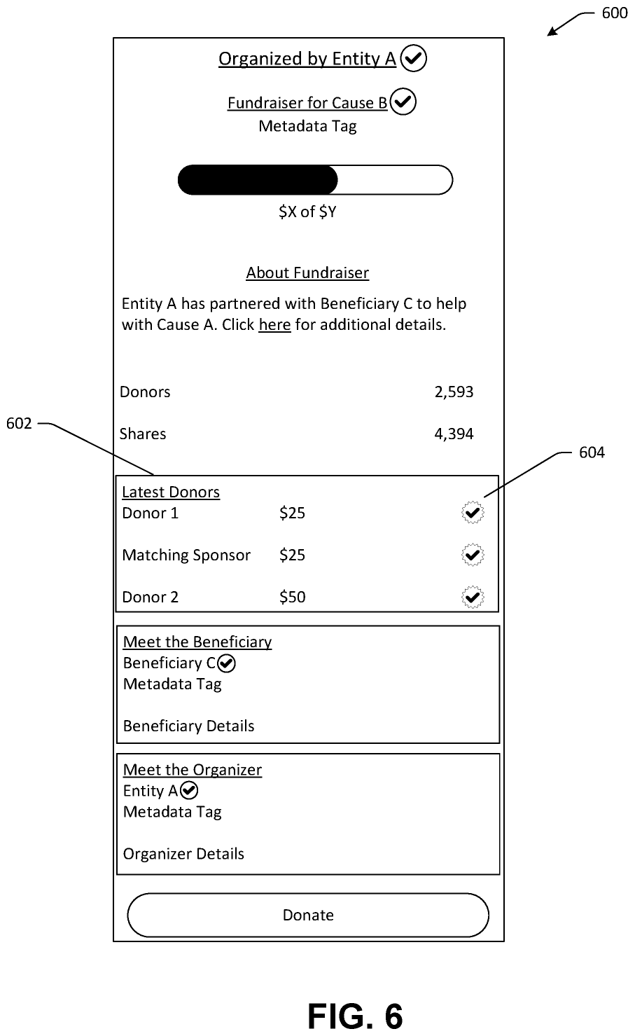

FIG. 6 is an example user interface 600 displayed on an example user device, where the user interface 600 is configured to present information indicating that a payment service has authenticated a donation or a matching donation associated with a fundraising event, according to an embodiment described herein. The user interface 600 may be one of the user interfaces 121 described with respect to FIG. 1, and may be displayed utilizing the payment application 122 as described herein.

The user interface 600 may include some or all of the data from the user interface 200 with respect to FIG. 2. For example, the user interface 600 may include an organizer indicator, which may provide identifying information about the organizer of the fundraising event. The user interface 600 may also include a beneficiary indicator, which may provide identifying information about the beneficiary of the fundraising event. Additionally, for the fundraising event at issue, a metadata tag may be generated and displayed. The user interface 600 may also include verifier icons. The verifier icons may provide an indication to viewers of the fundraising event that the entity associated with a given verifier icon has been verified or otherwise authenticated by the payment service. The user interface 600 may also include a progress indicator, which may be configured to display a real time indication of how much money has been raised for the fundraising event and what the goal of the fundraising event is. The user interface 600 may also include fundraiser details, which may include text and images that provide details about the fundraising event. The fundraiser details may be provided by the organizer of the fundraising event or may be determined by the payment service. The user interface 600 may also include dynamic data associated with the fundraising event. The examples of dynamic data include a latest donation amount, a number of donations, and a number of shares of the fundraising event. The user interface 600 may also include beneficiary details and organizer details. The user interface 600 may also include a donate element, which may be configured to be selected to initiate a process of donating to the fundraising event.

In addition to the above, the user interface 600 may include a donors portion 602, which may provide an indication of some or all of the donors that have donated to the fundraising event as well as information about the donations. The information may include an identifier of the donor, particularly where user consent to identify the donor has been provided, an amount of the donations, and any other information about the donation such as a time and day of the donation. The donors portion 602 may also include a verification icon 604. The verification icon 604 may be presented when the payment service determines that the donation has been confirmed and that the funds associated with the donation have been withdrawn from the specific user account associated with the donation or that the funds have been deposited into a holding account of the payment service. This may provide a form of verification signal to users viewing the fundraising event that the donations that have been made have been verified as occurring by the payment service. As shown in FIG. 6, in addition to showing verification signals of user donations, verification signals of matching sponsor donations may also be provided, which may show users that the fundraising event is accurately matching donations as they come in. This may incentivize additional donations by additional users.

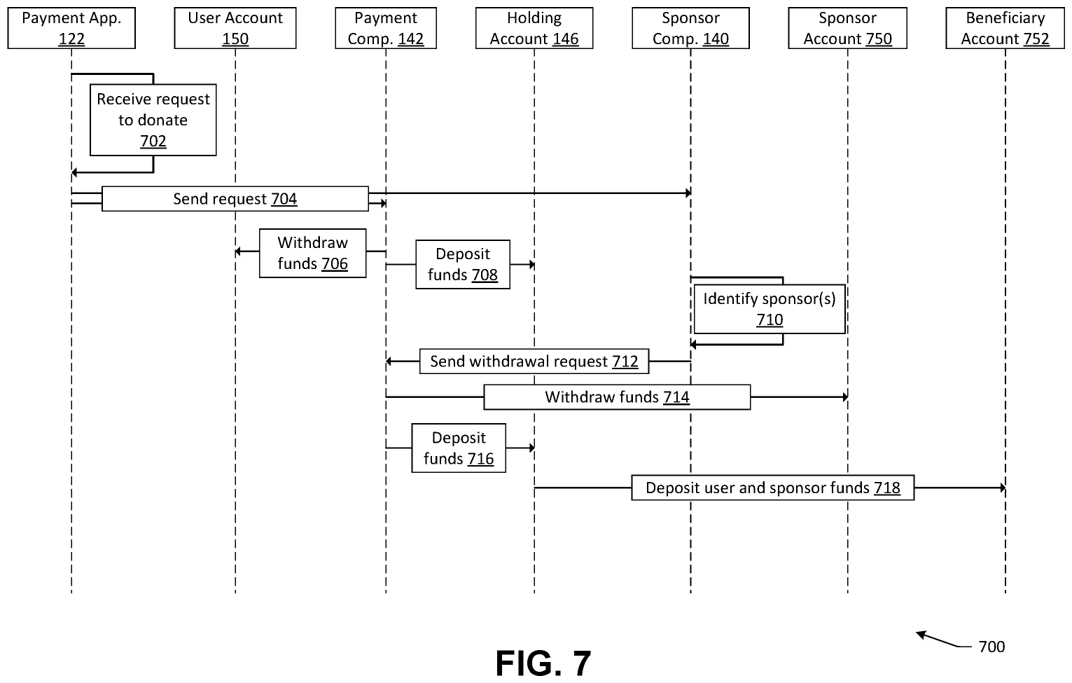

FIG. 7 is a sequence diagram showing an example process for making a donation and a matching donation to a fundraising event, according to an embodiment described herein. The processes described with respect to FIG. 7 are presented sequentially from blocks 702 to 718. However, it should be understood that the processes need not be performed in the order represented in FIG. 7 and that at least some of the processes may be performed in parallel with other processes.

At block 702, the payment application 122 may receive a request to donate funds to a fundraising event. As described more fully above, the request may be associated with a user interaction with an interactive element associated with the fundraising event. The user may have selected a donation element of a user interface and entered the necessary information to determine an amount of the donation and to authenticate the user. In other examples, the donation request may be based solely on the selection of the donation element and no additional user input may be needed.

At block 704, the payment application 122 may send data associated with the request to one or more components of the payment service 104. For example, the payment application 122 may send data associated with the request to a payment component 142 and to a sponsor component 140. The data associated with the request may include information associated with the donor, the fundraising event, the donation itself, a group the user belongs to, etc.

At block 706, the payment component 142 may receive the data representing the request and may withdraw funds from a user account 150 associated with the user. For example, a user profile associated with the payment application 122 may be utilized to determine which user account 150 to withdraw funds from. The payment component 142 may withdraw the funds from the user account 150 in the amount indicated by the donation request.

At block 708, the payment component 142 may deposit the funds withdrawn from the user account 150 into a holding account 146, which may be associated with the payment service 104. For example, the funds may not be deposited directly into an account associated with the beneficiary of the fundraising event until one or more conditions have been met. Those conditions may include receipt of funds from sponsors, satisfying a fundraising amount threshold, satisfying a number of donations, etc., for example. The holding account 146 may be associated with the payment service 104 or may be associated with a third party responsible for holding funds, such as in an escrow account.

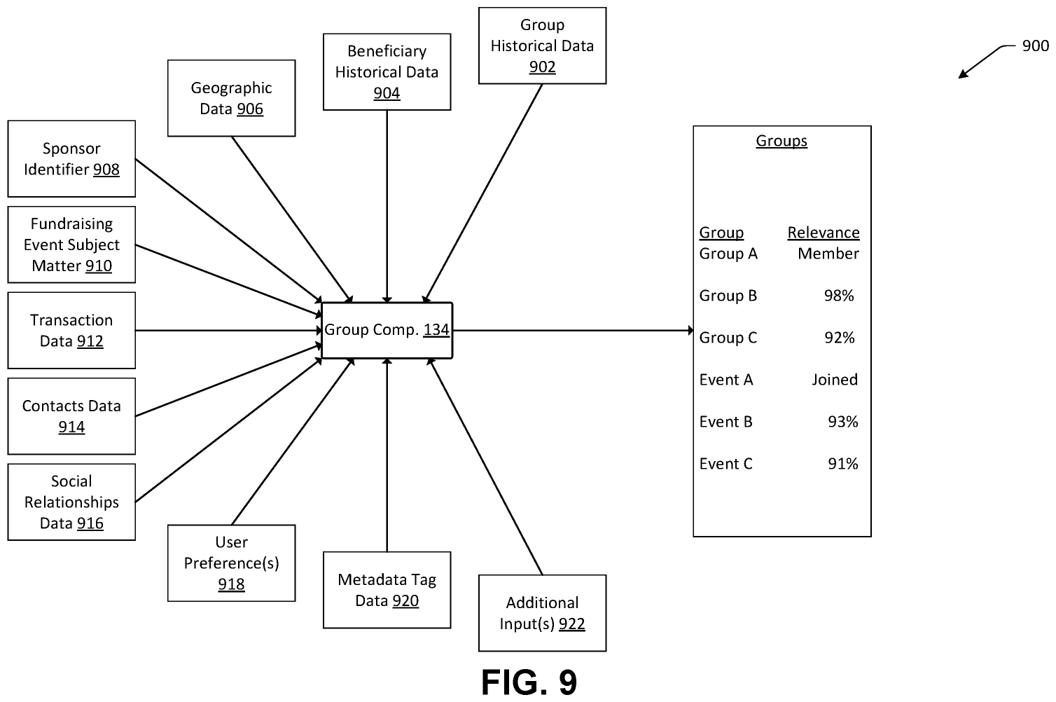

At block 710, the sponsor component 140 may have received the data associated with the donation request and may initiate a process for identifying a matching sponsor. Identification may be based on context data, such as historical data associated with a group of users for the fundraising event, historical data associated with the beneficiary, geographic data, sponsor preferences, fundraising event subject matter, transaction data associated with the user or the potential sponsor, contacts data associated with the user, social relationship data, user preferences of the donor, metadata tag data, or other inputs, for example. One or more machine learning models may be generated and trained for the purpose of identifying matching sponsors. Additional details on utilizing context data for identifying matching sponsor is provided with respect to FIG. 8 and FIG. 9.

At block 712, the sponsor component 140 may send a withdrawal request to the payment component 142 for additional funds from the sponsor account 750. In some examples, this withdrawal request may be performed automatically in response to identifying the sponsor. In other examples, one or more checks may be performed prior to sending the withdrawal request. For example, the checks may include requesting sponsor confirmation prior to requesting withdrawal, determining that a match limit associated with the sponsor has not been satisfied, or other processes to ensure that the matching sponsor has provided consent to withdraw the funds as a sponsorship match for a given donation.

At block 714, the payment component 142 may withdraw the additional funds from the sponsor account 750 associated with the matching sponsor. For example, a user profile associated with sponsor may be utilized to determine which sponsor account 750 to withdraw funds from. The payment component 142 may withdraw the funds from the sponsor account 750 in the amount indicated by the sponsorship match.

At block 716, the payment component 142 may deposit the additional funds into the holding account 146. For example, the additional funds may not be deposited directly into an account associated with the beneficiary of the fundraising event until one or more conditions have been met. Those conditions may include receipt of funds from other sponsors, satisfying a fundraising amount threshold, satisfying a number of donations, etc., for example. The holding account 146 may be associated with the payment service 104 or may be associated with a third party responsible for holding funds, such as in an escrow account. In examples, the transfers of funds as described herein may be made in real-time or near-real-time such that when a user requests that a donation be made, the transfer of funds from the user's account to the holding account 146 may be made in real-time or near-real-time. The same may occur for the matching sponsor donation.

At block 718, the payment service 104 may deposit the funds from the donation and the additional funds from the matching sponsor from the holding account 146 to a beneficiary account 752 associated with the beneficiary. Deposit of such funds may be based at least in part on the one or more conditions described herein being satisfied. In examples, a notification of the one or more conditions being satisfied may be presented to the donors, sponsors, or other entities associated with the fundraising event.

FIG. 8 is a conceptual diagram showing components of a system 800 utilized for identifying a matching sponsor associated with a fundraising event, according to an embodiment described herein. FIG. 8 may include some of the same components as described with respect to FIG. 1. For example, the system 800 may include a sponsor component 140 and a payment component 142. The system 800 may also include various types of data, described herein as context data, that may be utilized by the sponsor component 140, as described below.

The data types of the context data described with respect to FIG. 8 may include group historical data 802, beneficiary historical data 804, geographic data 806, one or more sponsor preferences 808, fundraising event subject matter data 810, transaction data 812, contacts data 814, social relationship data 816, one or more user preferences 818, metadata tag data 820, and one or more additional inputs 822. To illustrate, the group historical data 802 may indicate groups that a given user has been affiliated with in the past, including members of those groups, purposes associated with the groups, keywords associated with the groups, fundraising events associated with the groups, etc. The beneficiary historical data 804 may indicate beneficiaries of fundraising events that a given user or sponsor has been affiliated with in the past. Geographic data 806 may indicate the geographic area or region associated with donors, potential sponsors, fundraising events, beneficiaries, etc. The sponsor preferences 808 may indicate how potential sponsors would like to be affiliated with fundraising events, such as subject matters of interest, groups of interest, geographic regions of interest, matching interest, donation amounts and frequency preferences, etc. The fundraising event subject matter data 810 may indicate a subject matter for a particular fundraising event, such as an event about forest conservation, curing a medical disease, etc. The transaction data 812 may include any data associated with transactions made on behalf of donors, potential sponsors, groups, etc., including goods and services that may have been purchased, monetary amounts, etc. The contacts data 814 may indicate user profile identifiers for individuals that a given donor or potential sponsor is associated with, such as from a communications application contact list, for example. The social relationship data 816 may indicate user profiles associated with “friends,” “followers,” and like from social media platforms. The user preferences 818 may indicate preferences associated with the donors, such as which fundraising events donors have indicated a desire to be affiliated with, subject matters of interest, groups of interest, geographic regions of interest, donation amounts and frequencies, etc. The metadata tag data 820 may indicate metadata tags associated with the donors, sponsors, beneficiaries, etc. and how such entities have utilized metadata tags with respect to the fundraising event at issue or prior fundraising events.

Some or all of this data may be utilized by the sponsor component 140 to determine one or more matching sponsors for a particular fundraising event or a particular donation. For example, the group historical data 802 may indicate that a potential sponsor was a matching sponsor for the group at issue or for a member of the group at issue. The beneficiary historical data 804 may indicate that a potential sponsor previously made a matching sponsor donation to a previous fundraising event associated with the beneficiary at issue. The geographic data 806 may indicate that a potential sponsor is located in the same or a similar geographic location as a donor at issue, another sponsor, or the beneficiary. The sponsor preferences 808 may indicate that a potential sponsor has set a preference to be recommended as a matching sponsor. The fundraising event subject matter 810 may indicate that subject matters identified as important to a potential sponsor match with the subject matter of a given fundraising event. The transaction data 812 may indicate that a potential sponsor has engaged in similar transactions to a donor or the beneficiary, or that the potential sponsor has engaged in transactions with the donor or beneficiary. The contacts data 814 may indicate that a potential sponsor is a contact of the donor or the beneficiary. The social relationships data 816 may indicate that a potential sponsor has a social media relationship with the donor or the beneficiary. The user preferences 818 may indicate that the user has selected a category of sponsors to which a potential sponsor belongs, among other preferences. The metadata tag data 820 may indicate that a potential sponsor has utilized a metadata tag associated with the donor or the beneficiary. In these and other scenarios, the sponsor component 140 may identify the one or more matching sponsors and interface with the payment component 142 to initiate a matching sponsor donation, as described more fully herein.

It should be understood that the processes described herein to identify a matching sponsor may also be utilized to identify a potential donor. For example, identifying a potential donor may be based at least in part on analysis of at least one of transaction data associated with the potential donor, contacts associated with the potential donor, or one or more social graphs associated with the potential donor, etc. As used herein, a social graph represents a set of data objects that are associated with each other. Each of the data objects may include user profiles, group profiles, devices, fundraising events, etc. that are associated with a given user, and the associations may include data that indicates that a connection (and what type of connection) is stored as between various data objects in the social graph. When a potential donor is identified, the system described herein may send message data to a device associated with the potential donor that causes display of an interactive element as described herein. The message data may be in the form of a recommendation, as described in more detail with respect to FIG. 11.

FIG. 9 is a conceptual diagram showing components of a system 900 utilized for determining one or more groups or fundraising events to associate with a user profile, according to an embodiment described herein. FIG. 9 may include some of the same components as described with respect to FIG. 1. For example, the system 900 may include a group component 134. The system 900 may also include various types of data that may be utilized by the group component 134, as described below.

The data types described with respect to FIG. 9 may include group historical data 902, beneficiary historical data 904, geographic data 906, one or more sponsor identifiers 908, fundraising event subject matter data 910, transaction data 912, contacts data 914, social relationship data 916, one or more user preferences 918, metadata tag data 920, and one or more additional inputs 922. To illustrate, the group historical data 902 may indicate groups that a given user has been affiliated with in the past, including members of those groups, purposes associated with the groups, keywords associated with the groups, fundraising events associated with the groups, etc. The beneficiary historical data 904 may indicate beneficiaries of fundraising events that a given user has been affiliated with in the past. Geographic data 906 may indicate the geographic area or region associated with donors, fundraising events, beneficiaries, etc. The sponsor identifiers 908 may indicate sponsors that a given user has been affiliated with in the past. The fundraising event subject matter data 910 may indicate a subject matter for a particular fundraising event, such as an event about forest conservation, curing a medical disease, etc. The transaction data 912 may include any data associated with transactions made on behalf of donors, potential sponsors, groups, etc., including goods and services that may have been purchased, monetary amounts, etc. The contacts data 914 may indicate user profile identifiers for individuals that a given donor is associated with, such as from a communications application contact list, for example. The social relationship data 916 may indicate user profiles associated with “friends,” “followers,” and like from social media platforms. The user preferences 918 may indicate preferences associated with the donors, such as which fundraising events donors have indicated a desire to be affiliated with, subject matters of interest, groups of interest, geographic regions of interest, donation amounts and frequencies, etc. The metadata tag data 920 may indicate metadata tags associated with the donors, sponsors, beneficiaries, etc. and how such entities have utilized metadata tags with respect to the fundraising event at issue or prior fundraising events.

Some or all of this data may be utilized by the group component 134 to determine one or more matching groups for a particular user to join or otherwise be involved with. For example, the group historical data 902 may indicate that a user was a matching user for a past group or was otherwise associated with a given group in the past. The beneficiary historical data 904 may indicate that a user previously donated to a previous fundraising event associated with a given beneficiary. The geographic data 906 may indicate that a user is located in the same or a similar geographic location other users of a given group. The sponsor identifiers 908 may indicate that a user has been associated with a sponsor to which other members of a group have also been associated with. The fundraising event subject matter 910 may indicate that subject matters identified as important to a user match with the subject matter of a given group. The transaction data 912 may indicate that a user has engaged in similar transactions to other users in a group. The contacts data 914 may indicate that a user is a contact of other users of a group. The social relationships data 916 may indicate that a user has a social media relationship with other members of a group. The user preferences 918 may indicate that the user has selected preferences that are similar to preferences of a group. The metadata tag data 920 may indicate that a user has utilized a metadata tag associated with the group or that members of the groups have utilized the metadata tag. It should be understood that interaction with interactive elements associated with fundraising events may be a type of context data utilized by the group component 134 to generate a group. When users interact with interactive elements, user profiles associated with those users may be associated with a group associated with the fundraising event. In these and other scenarios, the group component 134 may identify the one or more matching groups to recommend to a user.

As shown in FIG. 9, a user interface with such actionable recommendations may be presented. The user interface may indicate which groups the user is already a member of or which fundraising events the user has joined. Additionally, the recommended groups may be indicated along with a relevance indicator, such as a percentage match for the group or fundraiser event. By so doing, techniques described herein enhance new and unexplored donation opportunities by leveraging the user connections in the payment service and/or third-party data such as social connections. Once a group is formed, the payment service can create these unique network connections (within the payment service or with third-party systems) among the group members to allow for seamless and real-time exchange of data, including funds. In examples, functionality may be made available to a group that is not necessarily available to an individual that is not associated with a group.

It should be understood that while groups and group recommendations are described above in the context of a fundraising event, the group recommendations may be unassociated with fundraising events and instead may be recommendations to join or start groups in general. Additionally, the functionality of a group may vary. For example, as a member of a group, sharing of expenses, donations, etc. may be performed by having a stored balance account associated with the group, the group account may be funded by individual members of the group, making donations on behalf of the group may be performed by individual members or by a group administrator, etc. Additionally, some groups may be private or otherwise be an invite-only group while others may be public. Each group may have its own identity, image, description, etc., and group membership may be presented on individual member profile pages. Additionally, for a given group, transactions may be shown and performed by the group and group activity may be shown in a group user interface.

When groups are discussed herein, those groups may represent a data object as stored in association with the payment service. The data object may indicate a multi-user profile or account that may be treated as its own profile or account, but instead of having a single user identifier associated with the data object, the data object may be associated with several user identifiers of the users of the group. Based on this, and with respect to fundraising events, the group may be associated with a stored balance account with a target amount, which may be considered a group savings account. The stored balance account may be funded by the members of the group, by non-members of the group, or donations, for example. In addition to using the stored balance account for fundraising purposes, the account may be utilized for other transactions associated with the group or members of the group, such as social investing, splitting expenses, etc. In some examples, any member of the group may initiate a transaction to withdraw funds from the stored balance account. In other examples, only administrators of the group or otherwise selected members may initiate such transactions. The groups as described herein may be private groups that require an invitation to join, while other groups may be public or otherwise may not require an invitation. The groups may have a name, image, description, etc., and group membership may be displayed in association with member profiles or otherwise on applications associated with the payment service. Groups may be searchable using the payment service or otherwise, and groups may be recommended as described herein. In addition to the above, groups may communicate with each other or engage in transactions with each other. In some examples, activity engaged in by the group may be displayed on a group activity user interface. Additionally, with respect to a given group member, functionality may be provided to invite non-members to the group, and for join or leaving the group.

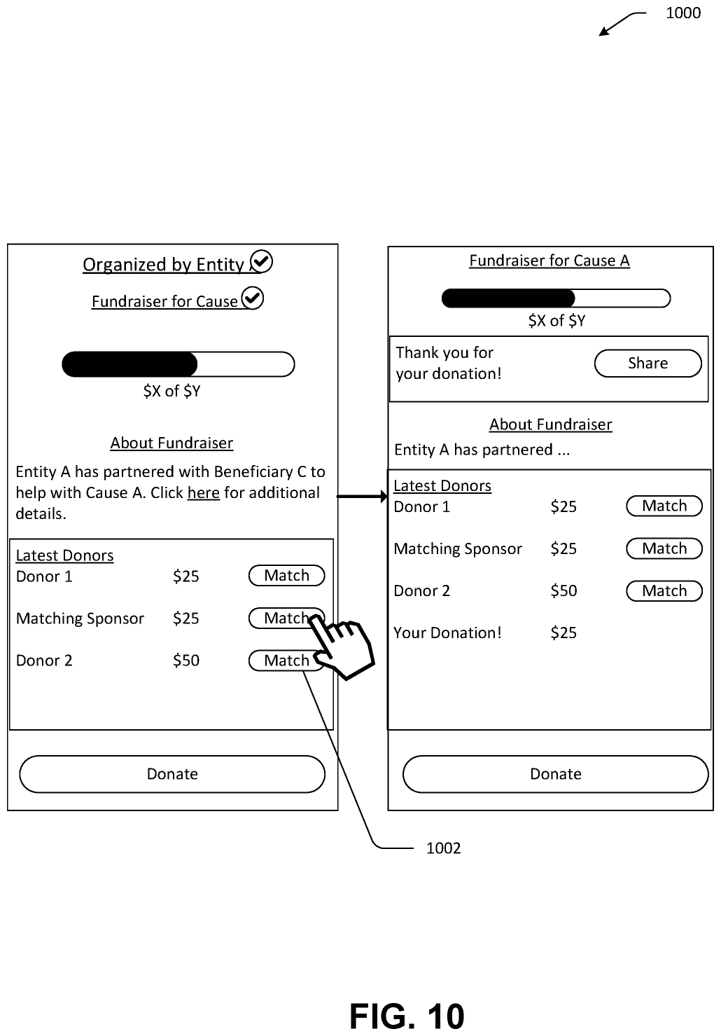

FIG. 10 is an example user interface 1000 displayed on an example user device, where the user interface 1000 is configured to present functionality to allow for a matching donation to be made to a previous matching donation, according to an embodiment described herein. The user interface 1000 may be one of the user interfaces 121 described with respect to FIG. 1, and may be displayed utilizing the payment application 122 as described herein.

The user interface 1000 may start by displaying information and functionality similar to that of the user interface 200 described with respect to FIG. 2. For example, the user interface 1000 may include an organizer indicator, which may provide identifying information about the organizer of the fundraising event. The user interface 1000 may also include a beneficiary indicator, which may provide identifying information about the beneficiary of the fundraising event. Additionally, for the fundraising event at issue, a metadata tag may be generated and displayed. The user interface 1000 may also include verifier icons. The verifier icons may provide an indication to viewers of the fundraising event that the entity associated with a given verifier icon has been verified or otherwise authenticated by the payment service. The user interface 1000 may also include a progress indicator, which may be configured to display a real time indication of how much money has been raised for the fundraising event and what the goal of the fundraising event is. The user interface 1000 may also include fundraiser details, which may include text and images that provide details about the fundraising event. The fundraiser details may be provided by the organizer of the fundraising event or may be determined by the payment service. The user interface 1000 may also include dynamic data associated with the fundraising event. The examples of dynamic data include a latest donation amount, a number of donations, and a number of shares of the fundraising event. The user interface 1000 may also include beneficiary details and organizer details. The user interface 1000 may also include a donate element, which may be configured to be selected to initiate a process of donating to the fundraising event.

In addition to the above, the user interface 1000 may include a match element 1002. When the match element 1002 is selected, the systems described herein may enable a user to match a matching sponsor donation. For example, an initial donation may be made as described herein. The system may then identify a matching sponsor and a matching sponsor donation may be made. Indicators of these donations may be provided on the user interface 1000 along with the match element 1002 to allow for another user to match the matching sponsor donation. A payment component of the payment service may perform operations similar to those described herein to withdraw funds for the match of the matching sponsor donation, and the user interface 1000 may be updated to display the match of the matching sponsor donation. In this way, matches may be “stacked” or otherwise proliferated to assist in the success of the fundraising event. The payment service may, in examples, selectively display matching donations to given users to increase the potential of stack matching. For example, if the matching sponsor is associated with a given user, an indication of that matching sponsor's donation may be presented to that user.

In other examples, stack matching may be performed automatically and without user input as described above. For example, where user preferences indicate that a matching donation is to be withdrawn when certain rules are met, the stack matching may be performed. For example, the criteria may be that a given user has made a donation, a given matching sponsor has made a donation, a certain number of matches have been made for a given donation, etc. For example, the rules mentioned above may indicate user preferences or system preferences indicating that when a condition occurs, the matching donation is made. An example may be that a donation is made in a certain amount or amount range, and when this occurs, not only does the matching sponsor donation occur, but a similar matching sponsor donation is made by one or more other profiles, such as a profile associated with the payment service. In some examples, consent to make a stacked matching donation may be garnered prior to a donation or matching sponsor donation being made, and then the payment service effectuates the stack matching by determining whether conditions indicated by the stack matching rules have been met.

FIGS. 11-15 are example processes for automated platform-based donation matching and security. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-10 and 16-20, although the processes may be implemented in a wide variety of other environments, architectures and systems.

FIG. 11 is a flow diagram of an example process 1100 for generating one or more recommendations associated with a fundraising event, according to an embodiment described herein. The order in which the operations or steps are described is not intended to be construed as a limitation, and any number of the described operations may be combined in any order and/or in parallel to implement process 1100.

At block 1102, the process 1100 may include determining one or more attributes of a fundraising event. For example, the payment service described herein may be configured to identify data associated with a fundraising event and determine what data corresponds to actionable attributes. Those attributes may include, by way of example, an organizer of the fundraising event, one or more sponsors involved in the event, a beneficiary of the event, a subject matter of the event, donor profiles associated with the event, donation amounts, matching sponsor amounts, geographic areas associated with the event or entities involved in the event, data indicating sharing of interactive elements, etc. These attributes may be considered context data that may be utilized to determine recommendations as described below.

At block 1104, the process 1100 may include receiving transaction data, user data, or context data. For example, the payment service may be configured to store transaction data associated with a user in one or more datastores as described herein. Additionally, the payment service may be configured to store user data, such as data associated with a user profile of the user, in the datastores. The transaction data may include any data associated with transactions that the user has engaged in utilizing the payment service or other services that the payment service has access to. The user data may include data about users themselves, including user preferences and user provided information.

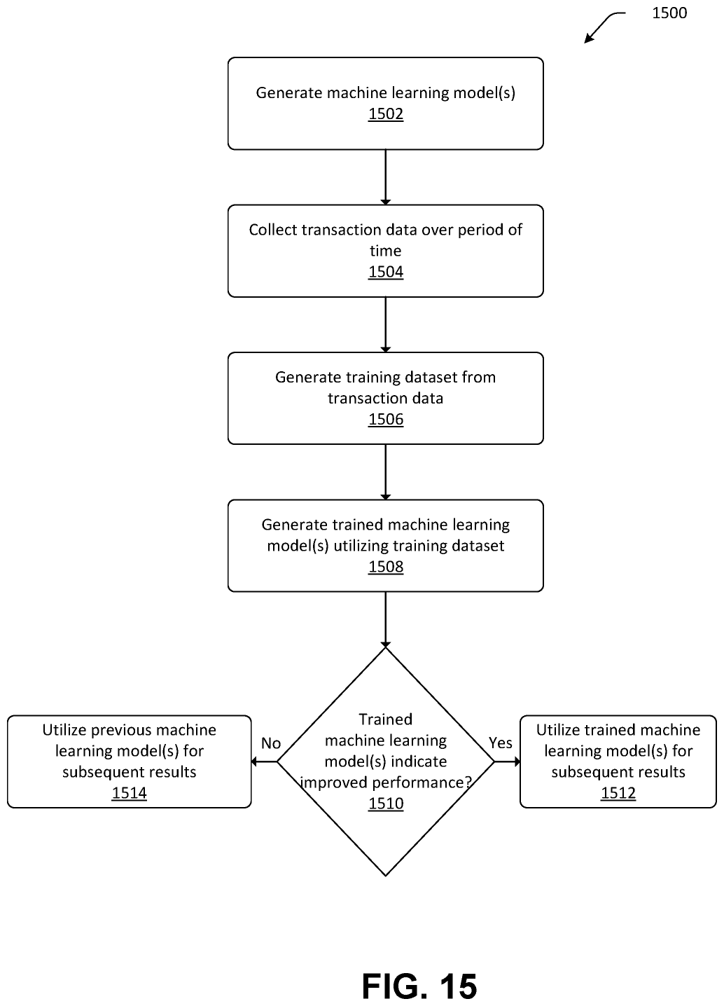

At block 1106, the process 1100 may include determining whether the transaction data, the user data, or the context data are related to the one or more attributes. For example, the payment service may determine whether a correlation can be made as between the transaction data or user data and the attributes of the fundraising event. For example, the payment service may determine that donors or matching sponsors for the event are in a user's contact list or are a part of the user's social media relationships. By way of further example, the correlation may be based at least in part on a geographic location of the event, the organizer, the beneficiary, the donors, etc. being similar to the user's geographic location. Additional correlations may include similarities associated with the user's transactions, groups associated with the payment service, subject matter associated with transactions, etc. It should be understood that when determining the correlations described herein, one or more machine learning models may be utilized. Additional details on the use of machine learning models is discussed with respect to FIG. 15, below.

In examples where the transaction data or the user data is not related to the one or more attributes, the process 1100 may end at block 1108. In this example, an actionable recommendation associated with the fundraising event may not be generated or sent to a user in question.

In examples where the transaction data or the user data is related to at least one of the one or more attributes, the process 1100 may include, at block 1110, generating an actionable recommendation associated with the fundraising event. For example, a recommendation component of the payment service may receive data indicating that a correlation has been found as between a fundraising event and a given user profile. The recommendation component may utilize this data to determine that a recommendation should be generated that the user associated with the user profile join the fundraising event. The recommendation may include text data, audio data, or image data that requests the user join the fundraising event. The recommendation may also include one or more interactive elements that allow user to provide user input to accept or reject the recommendation. The recommendation may also include a command that, when received by a user device of the user, causes the payment application to enable and display the recommendation. In some examples, the command may cause the payment application to transition from running in the background of the user device to running in the foreground of the user device.

At block 1112, the process 1100 may include determining whether user input data is received requesting to join the fundraising event in response to the recommendation. For example, the user may view the recommendation and may provide user input accepting or rejecting the recommendation. User input data corresponding to the user input may be sent from the payment application to the payment service.

In examples where such user input data is not received, the process 1100 may end at block 1108. In this example, while a recommendation related with the fundraising event was sent to the user, the user did not provide the appropriate consent or otherwise provide an indication that the user wanted to accept the recommendation. As such, a user profile associated with the user may not be joined with the fundraising event, at least in response to the recommendation.

In examples where the user input data is received, the process 1100 may include, at block 1114, associating a user profile of the user with the fundraising event. For example, an identifier of the user profile may be associated with an identifier of the fundraising event. The user profile may also be added to a group associated with the fundraising event or otherwise may displayed on a user interface associated with the fundraising event. This may allow the user to show that the user is associated with the fundraising event, or to participate in the fundraising event, or to utilize functionality associated with the group at issue, etc. In this manner, techniques described herein enhance new and unexplored donation opportunities by leveraging the user connections in the payment service and/or third-party data such as social connections. Once a group is formed, the payment service can create these unique network connections (within the payment service or with third-party systems) among the group members to allow for seamless and real-time exchange of data, including funds. In examples, functionality may be made available to a group that is not necessarily available to an individual that is not associated with a group.

FIG. 12 is a flow diagram of an example process 1200 for utilizing tax-based functionality in association with a fundraising event, according to an embodiment described herein. The order in which the operations or steps are described is not intended to be construed as a limitation, and any number of the described operations may be combined in any order and/or in parallel to implement process 1200.

At block 1202, the process 1200 may include facilitating a donation from a user account to a beneficiary account. For example, as described in more detail above, the payment service described herein may withdraw funds from a user account of the user and deposit the funds into a holding account of the payment service. The payment service may also identify one or more matching sponsors and withdraw additional funds from a sponsor account. Those additional funds may be deposited in the holding account, and the funds and additional funds may be withdrawn from the holding account and deposited into the beneficiary account when one or more conditions associated with the fundraising event are met. Examples of such conditions are provided elsewhere herein, but include a fundraising goal of the event being met.

At block 1204, the process 1200 may include generating transaction data for the donation. For example, when the donation is made, the payment service may generate data indicating which user profile was associated with the donation, the amount of the donation, a time of the donation, an identifier of the beneficiary, an identifier of the fundraising event, and whether the donation has been indicated as meeting requirements for a tax write off, write down, deferment, etc.

At block 1206, the process 1200 may include determining whether tax functionality associated with the payment service has been enabled for the payment application of the user. For example, many functionalities may be associated with the payment application of the payment service. Those functionalities may include, for example, requesting payment from other users, making a payment to other users, utilizing a digital payment instrument for a contactless payment, other functionality associated with payment instruments, investment related functionality, functionality associated with cryptocurrency, and tax-related functionality. While in some examples all of this functionality may be enabled during setup of the payment application on the user device, some functionality may be enabled after a user provides consent to do so.

In examples where the tax functionality has not been enabled, the process 1200 may include, at block 1208, sending a recommendation to a user device of the user to enable the tax functionality. For example, the recommendation may be surfaced in the payment application and may indicate that tax benefits are possible given the donation that was made. The recommendation may include interactive elements to allow the user to provide user input to accept or reject the recommendation. When accepted, the tax functionality may be enabled in association with the user profile of the user.

In examples where the tax functionality has been enabled, the process 1200 may include, at block 1210, storing the transaction data associated with the donation either in CRM of the user device or in a secure datastore of the payment service. For example, given the sensitive nature of tax-related data, the data may be stored on the user device such that it is not unnecessarily transmitted away from the device. In other examples, given that the payment application and the payment service may be associated with each other, the transaction data may be encrypted and the encrypted data may be sent from the user device to the payment service.

At block 1212, the process 1200 may include determining whether a trigger for a tax event has occurred. For example, the trigger may include a user providing user input to view, generate, or file tax-related information. The trigger may also be unassociated with user input. For example, once a calendar year has been completed, the payment service may determine that certain tax documentation may be generated and may do so. Other triggers may include the donation itself, refunds of donations, etc.

In examples where a trigger for the tax event has not occurred, the process 1200 may include, at block 1214, maintaining the transaction data until a trigger occurs. For example, the transaction data for the donation may be maintained until a trigger event occurs, until a predefined period of time has lapsed, or until user input is received requesting that the transaction data not be maintained.

In examples where a trigger for the tax event has occurred, the process 1200 may include, at block 1216, generating one or more tax documents or otherwise performing a tax-related action. Generation of the one or more tax documents may include the generation of documents verifying the donation, summarizing donations across a given year, filling out government-provided tax forms, etc. In examples, the tax-related action may include completing such forms, displaying such forms, or filing such forms on behalf of the user to comply with tax statutes and regulations.

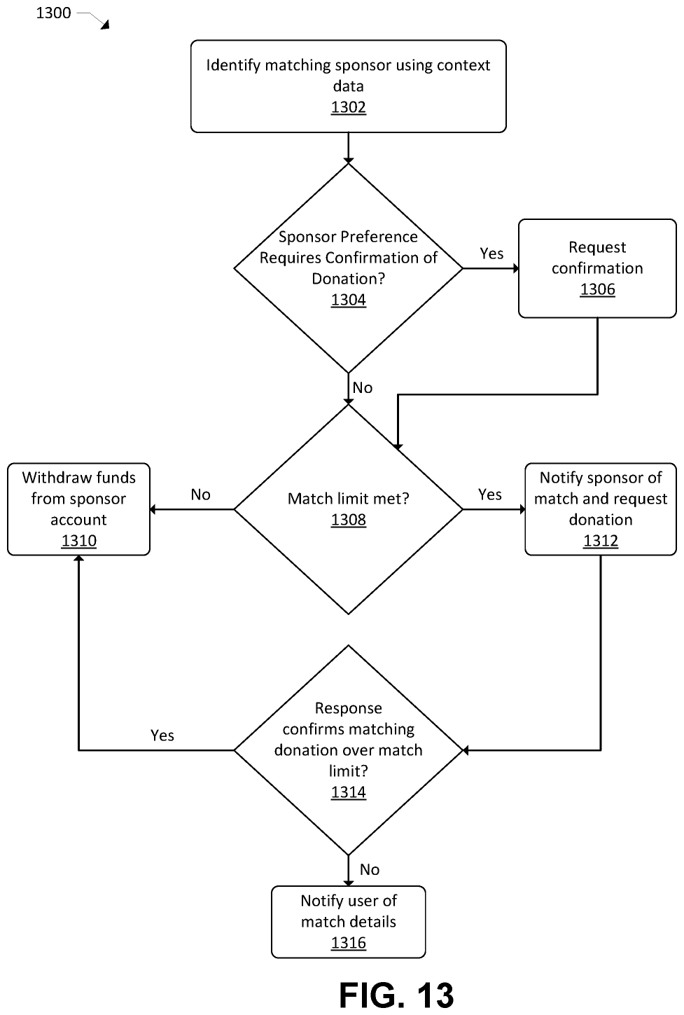

FIG. 13 is a flow diagram of an example process 1300 for determining whether a match limit has been met for a matching sponsor donation, according to an embodiment described herein. The order in which the operations or steps are described is not intended to be construed as a limitation, and any number of the described operations may be combined in any order and/or in parallel to implement process 1300.

At block 1302, the process 1300 may include identifying a matching sponsor for a donation utilizing context data. For example, a sponsor component of the payment service may be configured to utilize information available to it to identifying one or more matching sponsors for a fundraising event or a given donation. Some example data types of the context data to be utilized by the sponsor component include group historical data, beneficiary historical data, geographic data, one or more sponsor preferences, fundraising event subject matter data, transaction data, contacts data, social relationship data, one or more user preferences, metadata tag data, and one or more additional inputs. To illustrate, the group historical data may indicate groups that a given user has been affiliated with in the past, including members of those groups, purposes associated with the groups, keywords associated with the groups, fundraising events associated with the groups, etc. The beneficiary historical data may indicate beneficiaries of fundraising events that a given user or sponsor has been affiliated with in the past. Geographic data may indicate the geographic area or region associated with donors, potential sponsors, fundraising events, beneficiaries, etc. The sponsor preferences may indicate how potential sponsors would like to be affiliated with fundraising events, such as subject matters of interest, groups of interest, geographic regions of interest, matching interest, donation amounts and frequency preferences, etc. The fundraising event subject matter data may indicate a subject matter for a particular fundraising event, such as an event about forest conservation, curing a medical disease, etc. The transaction data may include any data associated with transactions made on behalf of donors, potential sponsors, groups, etc., including goods and services that may have been purchased, monetary amounts, etc. The contacts data may indicate user profile identifiers for individuals that a given donor or potential sponsor is associated with, such as from a communications application contact list, for example. The social relationship data may indicate user profiles associated with “friends,” “followers,” and like from social media platforms. The user preferences may indicate preferences associated with the donors, such as which fundraising events donors have indicated a desire to be affiliated with, subject matters of interest, groups of interest, geographic regions of interest, donation amounts and frequencies, etc. The metadata tag data may indicate metadata tags associated with the donors, sponsors, beneficiaries, etc. and how such entities have utilized metadata tags with respect to the fundraising event at issue or prior fundraising events. Some or all of this data may be utilized by the sponsor component to determine one or more matching sponsors for a particular fundraising event or a particular donation.

At block 1304, the process 1300 may include determining whether a sponsor preference of the sponsor requires confirmation of the matching donation prior to withdrawing funds from a sponsor account. For example, a given sponsor may have indicated preferences for when matching sponsor donations should be made. Those preferences may be associated with the subject matter of donations, the timing of donations, beneficiaries, organizers, donors, or details about how automatic withdrawal of funds is to occur.

In examples where the sponsor preference requires confirmation, the process 1300 may include, at block 1306, requesting confirmation from the sponsor. For example, as opposed to automatically withdrawing funds from the sponsor account when the sponsor is identified as a matching sponsor, the preferences may indicate that confirmation be provided by the sponsor first. To do so, the payment service may send an indication to a device associated with the sponsor that the sponsor has been identified to make a matching donation and may provide details about the fundraising event or the donation at issue. If the sponsor wishes to move forward with the matching donation, the sponsor may provide user input to do so.

In examples where the sponsor preference does not require confirmation or where confirmation has been received from the sponsor, the process 1300 may include, at block 1308, determining whether a match limit associated with the sponsor has been met. For example, the sponsor preferences may indicate a maximum amount of money that is to be utilized in a given period of time for matching sponsor donations. The match limit may be based on the maximum amount of money, or on other factors such as a number of matches the sponsor has been involved in.

In examples where the match limit has not been met, the process 1300 may include, at block 1310, withdrawing funds from the sponsor account for the matching sponsor donation. Withdrawing funds from the sponsor account may be performed as described in more detail with respect to FIG. 7.

In examples where the match limit has been bet, the process 1300 may include, at block 1312, notifying the sponsor of the matching opportunity and requesting that the sponsor provide a matching donation. For example, even when the match limit for a sponsor has been met, the sponsor may still desire to make the matching donation in certain scenarios. To allow for this possibility, a notification may be sent that includes details of the fundraising event and request that the sponsor provide input on whether to move forward with the matching donation even though the match limit has been met.

At block 1314, the process 1300 may include determining whether a response from the sponsor confirms the matching donation over the match limit. For example, the sponsor may provide user input that either confirms that the matching donation should occur or rejects the request to make the matching donation.

In examples where the response confirms the matching donation, the process 1300 may include, at block 1310, withdrawing funds from the sponsor account for the matching sponsor donation. This process may be performed in a similar manner as described above with respect to when the match limit has not been met.

In examples where the response does not confirm the matching donation or where no response is received, the process 1300 may include, at block 1316, notifying the user associated with the donation that a matching sponsor was not identified or otherwise that a matching sponsor donation was not made. This may provide the user with the ability to request a refund of the donation based on a matching donation not being made, or the user may indicate that the user wishes to make the donation despite a matching donation not being made. In other examples, the process 1300 may include identifying another sponsor for the donation and starting the process over at block 1304.

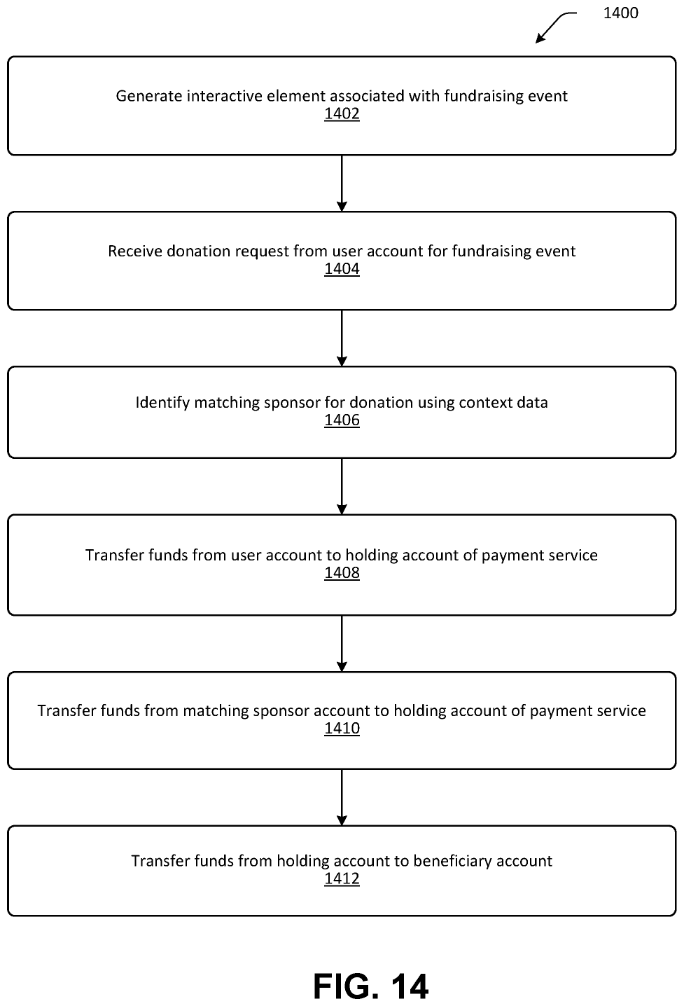

FIG. 14 is a flow diagram of an example process 1400 for automated platform-based donation matching and security, according to an embodiment described herein. The order in which the operations or steps are described is not intended to be construed as a limitation, and any number of the described operations may be combined in any order and/or in parallel to implement process 1400.

At block 1402, the process 1400 may include generating an interactive element associated with a fundraising event. For example, an interactive element component may be configured to generate interactive elements associated with fundraising events. For example, a fundraising event may be initiated by any user of a payment application associated with a payment service. User input may be received via the payment application for the organizer of the event, the sponsor if any, details on the cause at issue, etc. Utilizing this information, the interactive element component may generate an interactive element that may be configured to be shared and displayed in the payment application and outside of the payment application, such as on one or more social media applications. This interactive element may be selected by other users to cause display of functionality associated with the fundraising event on a user device. The functionality may be particularly robust and may update on the fly to provide potential donors with real time information about the fundraising event. Such information may include progress toward a fundraising goal, up-to-date number of donations and shares, details about the beneficiary, details about the organizer, indicators of whether the entities involved in the fundraising event predesignated as trustworthy, etc. The interactive element may be shareable and may be embedded with data that allows for the functionality described above to occur. Alternatively or additionally, the interactive element can be modified depending on the platform (e.g., the payment service) where it was generated, the platform where it is being shared or displayed (e.g., a social network or a fundraising platform), or the platform where it is being sent for receiving donations (e.g., a text messaging platform). For example, the interactive element may include attributes of the platform(s) to allow such modification. In this manner, the interactive element conforms to the technical specifications of the platform.

At block 1404, the process 1400 may include receiving a donation request from a user account for the fundraising event. As described more fully above, the request may be associated with a user interaction with an interactive element associated with the fundraising event. The user may have selected a donation element of a user interface and entered the necessary information to determine an amount of the donation and to authenticate the user.

At block 1406, the process 1400 may include identifying a matching sponsor for the donation utilizing context data. For example, a sponsor component of the payment service may be configured to utilize information available to it, including context data, to identifying one or more matching sponsors for a fundraising event or a given donation. Some example data types of the context data to be utilized by the sponsor component include group historical data, beneficiary historical data, geographic data, one or more sponsor preferences, fundraising event subject matter data, transaction data, contacts data, social relationship data, one or more user preferences, metadata tag data, and one or more additional inputs. To illustrate, the group historical data may indicate groups that a given user has been affiliated with in the past, including members of those groups, purposes associated with the groups, keywords associated with the groups, fundraising events associated with the groups, etc. The beneficiary historical data may indicate beneficiaries of fundraising events that a given user or sponsor has been affiliated with in the past. Geographic data 806 may indicate the geographic area or region associated with donors, potential sponsors, fundraising events, beneficiaries, etc. The sponsor preferences may indicate how potential sponsors would like to be affiliated with fundraising events, such as subject matters of interest, groups of interest, geographic regions of interest, matching interest, donation amounts and frequency preferences, etc. The fundraising event subject matter data may indicate a subject matter for a particular fundraising event, such as an event about forest conservation, curing a medical disease, etc. The transaction data may include any data associated with transactions made on behalf of donors, potential sponsors, groups, etc., including goods and services that may have been purchased, monetary amounts, etc. The contacts data may indicate user profile identifiers for individuals that a given donor or potential sponsor is associated with, such as from a communications application contact list, for example. The social relationship data may indicate user profiles associated with “friends,” “followers,” and like from social media platforms. The user preferences may indicate preferences associated with the donors, such as which fundraising events donors have indicated a desire to be affiliated with, subject matters of interest, groups of interest, geographic regions of interest, donation amounts and frequencies, etc. The metadata tag data may indicate metadata tags associated with the donors, sponsors, beneficiaries, etc. and how such entities have utilized metadata tags with respect to the fundraising event at issue or prior fundraising events. Some or all of this data may be utilized by the sponsor component to determine one or more matching sponsors for a particular fundraising event or a particular donation.

At block 1408, the process 1400 may include transferring funds from the user account to a holding account of the payment service. For example, a user profile associated with the payment application may be utilized to determine which user account to withdraw funds from. A payment component may withdraw the funds from the user account in the amount indicated by the donation request. Then, the payment component may deposit the funds withdrawn from the user account into a holding account, which may be associated with the payment service. For example, the funds may not be deposited directly into an account associated with the beneficiary of the fundraising event until one or more conditions have been met. Those conditions may include receipt of funds from sponsors, satisfying a fundraising amount threshold, satisfying a number of donations, etc., for example. The holding account 146 may be associated with the payment service or may be associated with a third party responsible for holding funds, such as in an escrow account.

At block 1410, the process 1400 may include transferring funds from a sponsor account to the holding account. The transferring of funds from the sponsor account to the holding account may be performed in the same or a similar manner as described above with respect to block 1408.

At block 1412, the process 1400 may include transferring funds from the holding account to a beneficiary account associated with a beneficiary of the fundraising event. Deposit of such funds may be based at least in part on the one or more conditions described herein being satisfied. In examples, a notification of the one or more conditions being satisfied may be presented to the donors, sponsors, or other entities associated with the fundraising event.

Additionally, or alternatively, the process 1400 may include generating the context data based at least in part on at least one of historical fundraiser data associated with a group of users, the group of users including the user; historical fundraiser data associated with the beneficiary; geographic data associated with the group of users; a user preference of the matching sponsor; a subject matter of the fundraising event; transaction data indicating transactions associated with the user performed utilizing the payment service; contacts data associated with the user; data representing social relationships of the user; a user preference associated with the user; and data indicating presence of a predefined hashtag associated with the fundraiser event.

Additionally, or alternatively, the process 1400 may include the matching sponsor being an entity other than a user in a group of the users, or the matching sponsor may be a user in the group of users, or the matching sponsor may be the payment service, particularly when a characteristic of the fundraising event corresponds to a predefined characteristic indicating desirability of the payment service to act as the matching sponsor.

Additionally, or alternatively, the process 1400 may include generating a group of users to associate with the fundraising event, the generating based at least in part on receiving indications that individual ones of the users have interacted with the interactive element. The process 1400 may also include associating user profiles of the users from the group of users with the fundraising event.

Additionally, or alternatively, the process 1400 may include determining that a characteristic of the fundraising event corresponds to a predefined characteristic indicating desirability of the payment service to act as the matching sponsor. In these examples, identifying the matching sponsor may include identifying the payment service as the matching sponsor.

Additionally, or alternatively, the process 1400 may include causing, on devices of a group of users associated with the fundraising event, display of a confirmation that the matching sponsor has transferred the additional funds, wherein the confirmation is selectable to display additional details of the transfer of the additional funds and receiving a selection of the confirmation. The process 1400 may also include displaying the additional details of the transfer of the additional funds, the details including an option for a given user of the group of users to make an additional matching donation and receiving a selection of the option. The process 1400 may also include facilitating a transfer of funds from an account of the given user to the account of the beneficiary based at least in part on receiving the selection.

Additionally, or alternatively, the process 1400 may include determining that an account associated with at least one additional user of a group of users associated with the fundraising event includes an indication that when the matching donation occurs the at least one additional user has authorized an additional matching donation to be made to the fundraising event. The process 1400 may also include, based at least in part on the indication, facilitating a transfer of funds from an account of the at least one additional user to the account associated with the beneficiary.

Additionally, or alternatively, the process 1400 may include, based at least in part on transferring the funds of the user and the additional funds of the matching sponsor from the holding account to the account associated with the beneficiary, generating data representing an icon configured to be displayed in association with an account identifier of the user, the icon indicating that the payment service has verified that at least one of (a) the user has donated to the fundraiser event or (b) the matching sponsor has donated to the fundraiser event. The process 1400 may also include causing display of the icon in association with the account identifier. Additionally, generation and display of up-to-date “verification signals” in association with a fundraising event may be essential to fundraising event success. For example, static icons or other visual identifiers may be generated and displayed as soon as a donation is made, a matching donation is made, an interactive element is shared, a user joins the fundraising event, a goal of the fundraising event is satisfied, etc. In some examples, visual identifiers can be dynamic such that they change shape or form based on the attributes of the fundraising event (e.g., the entity to which the donation is made, the amount of donation, and so on). Further, visual identifiers can be tied to non-fungible tokens (NFTs), for example, if the donation is made via a digital currency, or if the donor has purchased NFTs from the fundraising event or otherwise available NFTs. Such verification signals that indicate certain actions are being taken in association with the digital fundraising event and after a certain event is complete (e.g., fundraising event), enable a robust system that shows potential donors that the fundraising event is secure and the current state of the fundraising event when a donation is made. This state tracking and provisioning of real-time verification signals enhances existing fundraising technology by providing more security than what is conventionally available.

Additionally, or alternatively, the process 1400 may include receiving user input data requesting that the icon be displayed in association with one or more social media platforms. The process 1400 may also include causing, utilizing one or more application programming interfaces (APIs) associated with the one or more social media platforms, the payment service to transmit a command to the one or more social media platforms, the command causing the icon to be displayed in association with a user profile of the user for the one or more social media platforms.

Additionally, or alternatively, the process 1400 may include receiving donations and matching donations over a period of time in association with the fundraising event. The process 1400 may also include generating confirmation data indicating details of the donations and the matching donations, the details including at least one of a number of users that have donated, a number of the matching donations, an average donation amount, or a number of contacts associated with given users that donated. The process 1400 may also include causing display of the confirmation data in association with the fundraising event.

Additionally, or alternatively, the process 1400 may include determining attributes of the fundraising event and determining, from transaction data associated with users of the payment service, a group of users having prior transactions that are relevant to the attributes of the fundraising event. The process 1400 may also include generating an actionable recommendation to participate in the fundraising event, the actionable recommendation including the interactive element. The process 1400 may also include sending the actionable recommendation to devices associated with the group of users.

Additionally, or alternatively, the process 1400 may include receiving user input data requesting that the interactive element be shared with an additional user associated with the payment service. The process 1400 may also include causing data representing the interactive element to be sent in a peer-to-peer message to a device associated with the additional user, the data causing the interactive element in the peer-to-peer message to be displayed on the device of the additional user.

Additionally, or alternatively, the process 1400 may include receiving user input data from a payment application residing on a device of the user requesting that the interactive element be shared with an additional user associated with the payment service, the payment application associated with the payment service. The process 1400 may also include causing data representing the interactive element to be sent to an instance of the payment application residing on a device of the additional user, the data causing the instance of the payment application to display the interactive element.

Additionally, or alternatively, the process 1400 may include importing information associated with the donation into a tax-based application associated with the payment service, the importing including formatting the information such that a tax-related document is configured to be generated that indicates the donation. The process 1400 may also include generating data representing the tax-related document based at least in part on the importing.

Additionally, or alternatively, the process 1400 may include, based at least in part on identifying the matching sponsor, determining whether a match limit associated with the matching sponsor has been met. The process 1400 may also include, in response to determining that the match limit has not be met, performing the facilitating of the transfer of the additional funds from the account of the matching sponsor to the holding account of the payment service or the account of the beneficiary. The process 1400 may also include, in response to determining that the match limit has been met, sending a request to proceed with the matching donation to a device associated with the matching sponsor, wherein performing the facilitating of the transfer of the additional funds is based at least in part on receiving a response to the request to proceed, the response confirming that the matching sponsor has permitted the transfer of the additional funds.

Additionally, or alternatively, the process 1400 may include determining one or more attributes of the fundraising event and determining that at least a portion of the one or more attributes are predefined for a matching campaign. The process 1400 may also include generating data representing the matching campaign based at least in part on the at least the portion of the one or more attributes being predefined for the matching campaign. In these examples, identifying the matching sponsor may be based at least in part on generating the data representing the matching campaign.

Additionally, or alternatively, the process 1400 may include generating a metadata tag for the fundraising event, the metadata tag configured to enable a page associated with the fundraising event to be displayed by selection of the metadata tag. The process 1400 may also include associating the metadata tag with the payment service such that, when a post is generated utilizing a payment application associated with the payment service, an association between the post and the fundraising event is generated.

FIG. 15 is a flow diagram of an example process 1500 for the generation and training of machine learning models to perform one or more of the processes described herein, according to an embodiment described herein. The order in which the operations or steps are described is not intended to be construed as a limitation, and any number of the described operations may be combined in any order and/or in parallel to implement process 1500.

At block 1502, the process 1500 may include generating one or more machine learning models. For example, the machine learning models may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases, such as the datastore(s) 130, and may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter predictive modelling may be performed to generate accurate predictive models.

At block 1504, the process 1500 may include collecting transaction data over a period of time. The transaction data may include any of the data described with respect to the datastore(s) 130, any data associated with fundraising events, any data described with respect to FIGS. 8, 9, 11, and 12, or any other data that may be utilized to perform the operations described herein. This information may include factors associated with the fundraising events, such as timing data, user feedback, interactions with the payment application, interactions with recommendations, etc.

At block 1506, the process 1500 may include generating a training dataset from the transaction data. Generation of the training dataset may include formatting the transaction data into input vectors for the machine learning model to intake, as well as associating the various data with the outcomes of fundraising events and recommendations.

At block 1508, the process 1500 may include generating one or more trained machine learning models utilizing the training dataset. Generation of the trained machine learning models may include updating parameters and/or weightings and/or thresholds utilized by the models to generate recommendations, user preferences, etc. based at least in part on the data from the training dataset.

At block 1510, the process 1500 may include determining whether the trained machine learning models indicate improved performance metrics. For example, a testing group may be generated where the outcomes of the fundraising event processes are known but not to the trained machine learning models. The trained machine learning models may generate results, which may be compared to the known results to determine whether the results of the trained machine learning model produce a superior result than the results of the machine learning model prior to training.

In examples where the trained machine learning models indicate improved performance metrics, the process 1500 may include, at block 1512, utilizing the trained machine learning models for generating subsequent results. For example, the trained machine learning models may be utilized to generate recommendations associated with fundraising events, groups, donors, sponsors, etc., for identifying matching sponsors, for generating interactive elements, etc. Additionally, the trained machine learning models may be utilized to adjust or recommend adjusting user preferences or condition thresholds as described herein. It should be understood that the trained machine learning models may be utilized in any scenario where models are utilized as described herein.

In examples where the trained machine learning models do not indicate improved performance metrics, the process 1500 may include, at block 1514, utilizing the previous iteration of the machine learning models for generating subsequent results.

FIG. 16 is an example environment with user devices, merchant devices, a payment service, and/or other systems that may be involved in a transaction, such as by utilizing the payment application as configured herein, according to an embodiment described herein. The environment 1600 includes server(s) 1602 that can communicate over a network 1604 with user devices 1606 (which, in some examples can be merchant devices 1608 (individually, 1608(A)-1608(N))) and/or server(s) 1610 associated with third-party service provider(s). The server(s) 1602 can be associated with a service provider that can provide one or more services for the benefit of users 1614, as described below. Actions attributed to the service provider can be performed by the server(s) 1602.

In examples, the server(s) 1602 may be the same as or similar to the payment service 104 from FIG. 1, which may include the same or similar components as described with respect to the payment service 104 of FIG. 1, including the fundraising component 129 as shown in FIG. 16. Further, the user devices 102 from FIG. 1 may have the same or similar components and perform the same or similar functionality as the user devices 1606 from FIG. 16. Additionally, the merchant devices 1608 may be associated with fundraising campaigns as described herein. Furthermore, the server(s) 1610 associated with third-party service provider(s) may be the same as or similar to the systems associated with fundraising events, social networking platforms, or the like, as described herein.

The environment 1600 can include a plurality of user devices 1606, as described above. Each one of the plurality of user devices 1606 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1614. The users 1614 can be referred to as customers, buyers, merchants, sellers, borrowers, employees, employers, payors, payees, couriers and so on. The users 1614 can interact with the user devices 1606 via user interfaces presented via the user devices 1606. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1606 can have an instance or versioned instance of an application, which can be downloaded from an application store, for example, which can present the user interface(s) described herein. In at least one example, a user 1614 can interact with the user interface via touch input, spoken input, or any other type of input.

As described above, in at least one example, the users 1614 can include merchants 1616 (individually, 1616(A)-1616(N)). In an example, the merchants 1616 can operate respective merchant devices 1608, which can be user devices 1606 configured for use by merchants 1616. For the purpose of this discussion, a “merchant” can be any entity that offers items (e.g., goods or services) for purchase or other means of acquisition (e.g., rent, borrow, barter, etc.). The merchants 1616 can offer items for purchase or other means of acquisition via brick-and-mortar stores, mobile stores (e.g., pop-up shops, food trucks, etc.), online stores, combinations of the foregoing, and so forth. In some examples, at least some of the merchants 1616 can be associated with a same entity but can have different merchant locations and/or can have franchise/franchisee relationships. In additional or alternative examples, the merchants 1616 can be different merchants. That is, in at least one example, the merchant 1616(A) is a different merchant than the merchant 1616(B) and/or the merchant 1616(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 1608 can have an instance of a POS application 1618 stored thereon. The POS application 1618 can configure the merchant device 1608 as a POS terminal, which enables the merchant 1616(A) to interact with one or more customers 1620. As described above, the users 1614 can include customers, such as the customers 1620 shown as interacting with the merchant 1616(A). For the purpose of this discussion, a “customer” can be any entity that acquires items from merchants. While only two customers 1620 are illustrated in FIG. 16, any number of customers 1620 can interact with the merchants 1616. Further, while FIG. 16 illustrates the customers 1620 interacting with the merchant 1616(A), the customers 1620 can interact with any of the merchants 1616.

In at least one example, interactions between the customers 1620 and the merchants 1616 that involve the exchange of funds (from the customers 1620) for items (from the merchants 1616) can be referred to as “transactions.” In at least one example, the POS application 1618 can determine transaction data associated with the POS transactions. Transaction data can include payment information, which can be obtained from a reader device 1622 associated with the merchant device 1608(A), user authentication data, purchase amount information, point-of-purchase information (e.g., item(s) purchased, date of purchase, time of purchase, etc.), etc. The POS application 1618 can send transaction data to the server(s) 1602 such that the server(s) 1602 can track transactions of the customers 1620, merchants 1616, and/or any of the users 1614 over time. Furthermore, the POS application 1618 can present a UI to enable the merchant 1616(A) to interact with the POS application 1618 and/or the service provider via the POS application 1618.

In at least one example, the merchant device 1608(A) can be a special-purpose computing device configured as a POS terminal (via the execution of the POS application 1618). In at least one example, the POS terminal may be connected to a reader device 1622, which is capable of accepting a variety of payment instruments, such as credit cards, debit cards, gift cards, short-range communication based payment instruments, and the like, as described below. In at least one example, the reader device 1622 can plug in to a port in the merchant device 1608(A), such as a microphone port, a headphone port, an audio-jack, a data port, or other suitable port. In additional or alternative examples, the reader device 1622 can be coupled to the merchant device 1608(A) via another wired or wireless connection, such as via a Bluetooth®, BLE, and so on. In some examples, the reader device 1622 can read information from alternative payment instruments including, but not limited to, wristbands and the like.

In some examples, the reader device 1622 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 1622, and communicate with the server(s) 1602, which can provide, among other services, a payment processing service. The server(s) 1602 associated with the service provider can communicate with server(s) 1610, as described below. In this manner, the POS terminal and reader device 1622 may collectively process transaction(s) between the merchants 1616 and customers 1620. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1622 of the POS system 1624 are shown as separate devices, in additional or alternative examples, the POS terminal and the reader device 1622 can be part of a single device. In some examples, the reader device 1622 can have a display integrated therein for presenting information to the customers 1620. In additional or alternative examples, the POS terminal can have a display integrated therein for presenting information to the customers 1620. POS systems, such as the POS system 1624, may be mobile, such that POS terminals and reader devices may process transactions in disparate locations across the world. POS systems can be used for processing card-present transactions and card-not-present (CNP) transactions, as described below.

A card-present transaction is a transaction where both a customer 1620 and his or her payment instrument are physically present at the time of the transaction. Card-present transactions may be processed by swipes, dips, taps, or any other interaction between a physical payment instrument (e.g., a card), or otherwise present payment instrument, and a reader device 1622 whereby the reader device 1622 is able to obtain payment data from the payment instrument. A swipe is a card-present transaction where a customer 1620 slides a card, or other payment instrument, having a magnetic strip through a reader device 1622 that captures payment data contained in the magnetic strip. A dip is a card-present transaction where a customer 1620 inserts a payment instrument having an embedded microchip (i.e., chip) into a reader device 1622 first. The dipped payment instrument remains in the payment reader until the reader device 1622 prompts the customer 1620 to remove the card, or other payment instrument. While the payment instrument is in the reader device 1622, the microchip can create a one-time code which is sent from the POS system 1624 to the server(s) 1610 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 1620 may tap or hover his or her payment instrument (e.g., card, electronic device such as a smart phone running a payment application, etc.) over a reader device 1622 to complete a transaction via short-range communication (e.g., NFC, RFID, Bluetooth®, BLE, etc.). Short-range communication enables the payment instrument to exchange information with the reader device 1622. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 1624, the server(s) 1602, and/or the server(s) 1610 may exchange payment information and transaction data to determine whether transactions are authorized. For example, the POS system 1624 may provide encrypted payment data, user authentication data, purchase amount information, point-of-purchase information, etc. (collectively, transaction data) to server(s) 1602 over the network(s) 1604. The server(s) 1602 may send the transaction data to the server(s) 1610. As described above, in at least one example, the server(s) 1610 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 1610 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 1610 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 1610 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 1610 associated therewith), and a payment authorization message is communicated from the issuer to the POS device via a path opposite of that described above, or via an alternate path.

As described above, the server(s) 1610, which can be associated with payment service provider(s), may determine whether the transaction is authorized based on the transaction data, as well as information relating to parties to the transaction (e.g., the customer 1620 and/or the merchant 1616(A)). The server(s) 1610 may send an authorization notification over the network(s) 1604 to the server(s) 1602, which may send the authorization notification to the POS system 1624 over the network(s) 1604 to indicate whether the transaction is authorized. The server(s) 1602 may also transmit additional information such as transaction identifiers to the POS system 1624. In one example, the server(s) 1602 may include a merchant application and/or other functional components for communicating with the POS system 1624 and/or the server(s) 1610 to authorize or decline transactions.

Based on the authentication notification that is received by the POS system 1624 from server(s) 1602, the merchant 1616(A) may indicate to the customer 1620 whether the transaction has been approved. In some examples, approval may be indicated at the POS system 1624, for example, at a display of the POS system 1624. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 1614 can access all of the services of the service provider. In other examples, the users 1614 can have gradated access to the services, which can be based on risk tolerance, IDV outputs, subscriptions, and so on. In at least one example, access to such services can be availed to the merchants 1616 via the POS application 1618. In additional or alternative examples, each service can be associated with its own access point (e.g., application, web browser, etc.).

The service provider can offer payment processing services for processing payments on behalf of the merchants 1616, as described above. For example, the service provider can provision payment processing software, payment processing hardware and/or payment processing services to merchants 1616, as described above, to enable the merchants 1616 to receive payments from the customers 1620 when conducting POS transactions with the customers 1620. For instance, the service provider can enable the merchants 1616 to receive cash payments, payment card payments, and/or electronic payments from customers 1620 for POS transactions and the service provider can process transactions on behalf of the merchants 1616.

As the service provider processes transactions on behalf of the merchants 1616, the service provider can maintain accounts or balances for the merchants 1616 in one or more ledgers. For example, the service provider can analyze transaction data received for a transaction to determine an amount of funds owed to a merchant 1616(A) for the transaction. In at least one example, such an amount can be a total purchase price less fees charged by the service provider for providing the payment processing services. Based on determining the amount of funds owed to the merchant 1616(A), the service provider can deposit funds into an account of the merchant 1616(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 1616(A) to a bank account of the merchant 1616(A) that is held at a bank or other financial institution (e.g., associated with the server(s) 1610). Scheduled deposits can occur at a prearranged time after a POS transaction is funded, which can be a business day after the POS transaction occurred, or sooner or later. In some examples, the merchant 1616(A) can access funds prior to a scheduled deposit. For instance, the merchant 1616(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 1616(A) can have a payment instrument that is linked to the stored balance that enables the merchant to access the funds without first transferring the funds from the account managed by the service provider to the bank account of the merchant 1616(A).

In at least one example, the service provider may provide inventory management services. That is, the service provider may provide inventory tracking and reporting. Inventory management services may enable the merchant 1616(A) to access and manage a database storing data associated with a quantity of each item that the merchant 1616(A) has available (i.e., an inventory). Furthermore, in at least one example, the service provider can provide catalog management services to enable the merchant 1616(A) to maintain a catalog, which can be a database storing data associated with items that the merchant 1616(A) has available for acquisition (i.e., catalog management services). In at least one example, the catalog may include a plurality of data items and a data item of the plurality of data items may represent an item that the merchant 1616(A) has available for acquisition. The service provider can offer recommendations related to pricing of the items, placement of items on the catalog, and multi-party fulfilment of the inventory.

In at least one example, the service provider can provide business banking services, which allow the merchant 1616(A) to track deposits (from payment processing and/or other sources of funds) into an account of the merchant 1616(A), payroll payments from the account (e.g., payments to employees of the merchant 1616(A)), payments to other merchants (e.g., business-to-business) directly from the account or from a linked debit card, withdrawals made via scheduled deposit and/or instant deposit, etc. Furthermore, the business banking services can enable the merchant 1616(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 1616 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 1616. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider 1612 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 1614 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 1616. In at least one example, the service provider can recommend and/or generate content items to supplement omni-channel presences of the merchants 1616. That is, if a merchant of the merchants 1616 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 1614 to set schedules for scheduling appointments and/or users 1614 to schedule appointments.

In some examples, the service provider can provide restaurant management services to enable users 1614 to make and/or manage reservations, to monitor front-of-house and/or back-of-house operations, and so on. In such examples, the merchant device(s) 1608 and/or server(s) 1602 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 1614 who can travel between locations to perform services for a requesting user 1614 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 1606.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 1614, voice inputs into a virtual assistant or the like, to determine intents of user(s) 1614. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1614 may be new to the service provider such that the user 1614 that has not registered (e.g., subscribed to receive access to one or more services offered by the service provider) with the service provider. The service provider can offer onboarding services for registering a potential user 1614 with the service provider. In some examples, onboarding can involve presenting various questions, prompts, and the like to a potential user 1614 to obtain information that can be used to generate a profile for the potential user 1614. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 1614 providing all necessary information, the potential user 1614 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 1610). That is, the service provider can offer IDV services to verify the identity of users 1614 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 1614 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 1610 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 1602) and/or the server(s) 1610 via the network(s) 1604. In some examples, the merchant device(s) 1608 are not capable of connecting with the service provider (e.g., the server(s) 1602) and/or the server(s) 1610, due to a network connectivity issue, for example. In additional or alternative examples, the server(s) 1602 are not capable of communicating with the server(s) 1610 due to network connectivity issue, for example. In such examples, devices may operate in “offline” mode where at least some payment data is stored (e.g., on the merchant device(s) 1608) and/or the server(s) 1602 until connectivity is restored and the payment data can be transmitted to the server(s) 1602 and/or the server(s) 1610 for processing.

In at least one example, the service provider can be associated with a hub, such as an order hub, an inventory hub, a fulfillment hub and so on, which can enable integration with one or more additional service providers (e.g., associated with the additional server(s) 1610). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 1606 that are in communication with one or more server computing devices 1602 of the service provider. That is, techniques described herein are directed to a specific implementation—or, a practical application—of utilizing a distributed system of user devices 1606 that are in communication with one or more server computing devices 1602 of the service provider to perform a variety of services, as described above. The unconventional configuration of the distributed system described herein enables the server(s) 1602 that are remotely-located from end-users (e.g., users 1614) to intelligently offer services based on aggregated data associated with the end-users, such as the users 1614 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1614 and user devices 1606. Furthermore, such features are changed dynamically based on the profiles of the users involved interacting with the GUIs. As such, techniques described herein are directed to improvements to computing systems.

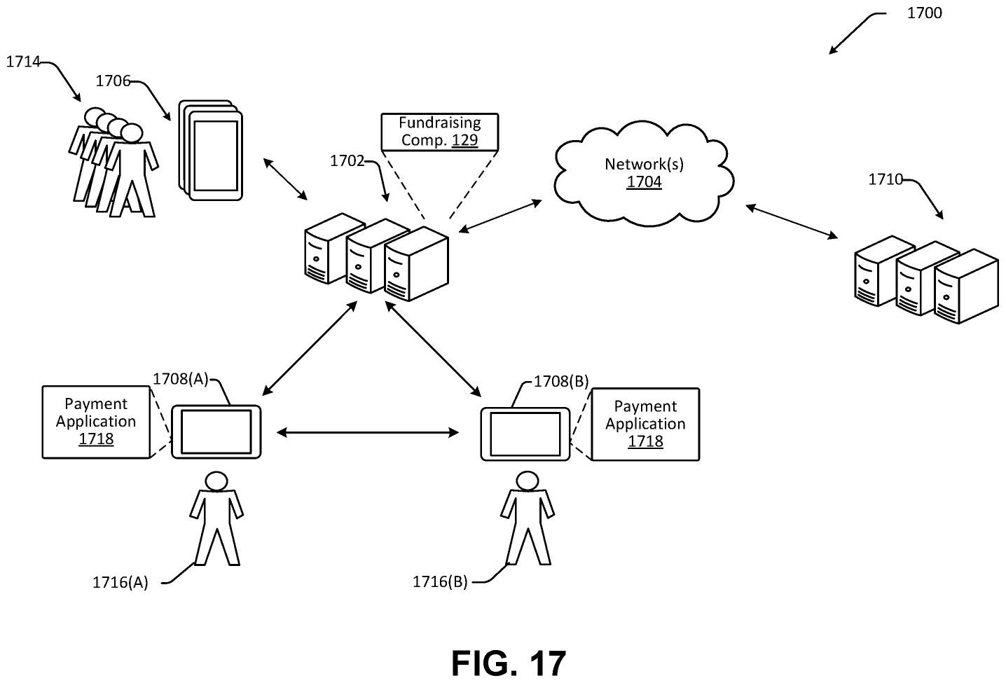

FIG. 17 is an example environment illustrating usage of the payment application, according to an embodiment described herein. The environment 1700 includes server(s) 1702 that can communicate over a network 1704 with user devices 1706 (which, in some examples can be user devices 1708 (individually, 1708(A), 1708(B)) and/or server(s) 1710 associated with third-party service provider(s). The server(s) 1702 can be associated with a service provider that can provide one or more services for the benefit of users 1714, as described below. Actions attributed to the service provider can be performed by the server(s) 1702. In some examples, the service provider referenced in FIG. 16 can be the same or different than the service provider referenced in FIG. 17.

As described herein, the server(s) 1702 may be the same or similar to the payment service 104 described with respect to FIG. 1, which may include the same or similar components as described with respect to the payment service 104 of FIG. 1, including the fundraising component 129 as shown in FIG. 17. The user devices 1706, 1708 may be the same or similar to the user devices 102 described with respect to FIG. 1. The server(s) 1710 associated with third-party service provider(s) may be the same as or similar to the systems associated with fundraising events, social networking platforms, or the like, as described herein.

The environment 1700 can include a plurality of user devices 1706, as described above. Each one of the plurality of user devices 1706 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1714. The users 1714 can be referred to as customers, buyers, merchants, sellers, borrowers, employees, employers, payors, payees, couriers and so on. The users 1714 can interact with the user devices 1706 via user interfaces presented via the user devices 1706. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1706 can have an instance or versioned instance of an application, which can be downloaded from an application store, for example, which can present the user interface(s) described herein. In at least one example, a user 1714 can interact with the user interface via touch input, spoken input, or any other type of input.

In at least one example, the service provider can provide a peer-to-peer payment service that enables peer-to-peer payments between two or more users 1714. Two users, user 1716(A) and user 1716(B) are illustrated in FIG. 17 as “peers” in a peer-to-peer payment. In at least one example, the service provider can communicate with instances of a payment application 1718 (or other access point) installed on devices 1706 configured for operation by users 1714. In an example, an instance of the payment application 1718 executing on a first device 1708(A) operated by a payor (e.g., user 1716(A)) can send a request to the service provider to transfer an asset (e.g., fiat currency, non-fiat currency, cryptocurrency, securities, gift cards, and/or related assets) from the payor to a payee (e.g., user 1716(B)) via a peer-to-peer payment. In some examples, assets associated with an account of the payor are transferred to an account of the payee. In some examples, assets can be held at least temporarily in an account of the service provider prior to transferring the assets to the account of the payee.

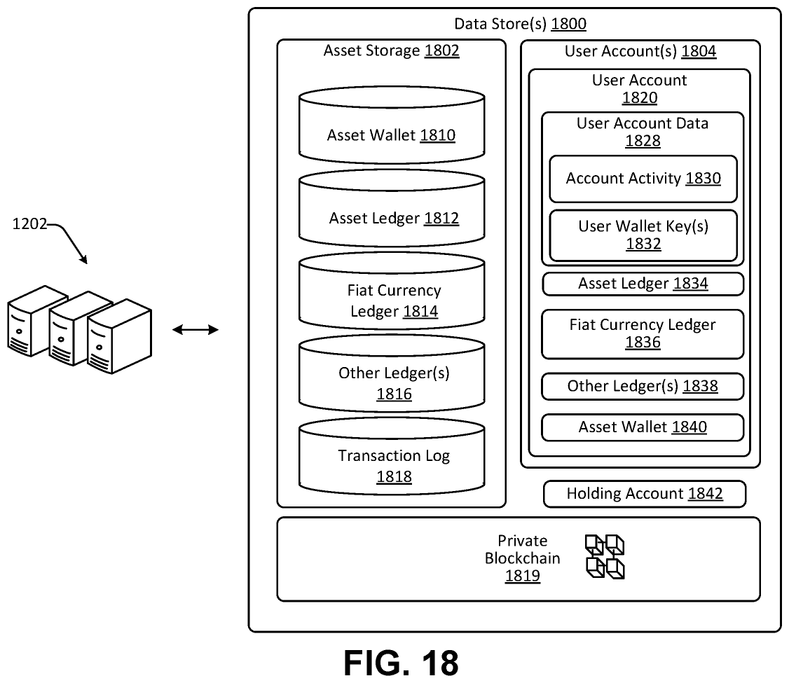

In some examples, the service provider can utilize a ledger system to track transfers of assets between users 1706. FIG. 18, below, provides additional details associated with such a ledger system. The ledger system can enable users 1706 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 1718 executing on user device(s) of payee(s). As an example, the service provider can transfer assets from an account of user 1716(A) to an account of the user 1716(B) and can send a notification to the user device 1708(B) of the user 1716(B) for presentation via a user interface. The notification can indicate that a transfer is in process, a transfer is complete, or the like. In some examples, the service provider can send additional or alternative information to the instances of the payment application 1718 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 1702 to treat the inputs as a request from the payor to transfer assets, where detection of the syntax triggers a transfer of assets. The currency indicator can correspond to various currencies including but not limited to, dollar ($), euro ( [symbol] ), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 1718 executing on the user devices 1706. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a given platform (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 17. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 1706 (e.g., mobile device or conventional personal computer (PC)) based on instructions transmitted to and from the server(s) 1702 (which, in such an example can be called a “messaging server”). In some instances, the messaging application can include a payment application with messaging capability that enables users of the payment application to communicate with one another. In such instances, the payment application can be executed on a user device 1706 based on instructions transmitted to and from the server(s) 1702 (e.g., the payment service discussed in this description or another payment service that supports payment transactions). In some examples, the messaging application can be provided by a third-party service provider associated with the server(s) 1710. In examples where the messaging application is a third-party service provider, the server(s) 1710 can be accessible via one or more APIs or other integrations.

As described above, the service provider can facilitate peer-to-peer transactions, which can enable users 1706 to transfer fiat currency, non-fiat currency, cryptocurrency, securities, or other assets, or portions thereof, to other users 1706. In at least one example, individual users can be associated with user accounts. Additional details associated with user accounts and the transfer of assets between users 1706 are described below with reference to FIG. 18.

Furthermore, the service provider of FIG. 17 can enable users 1706 to perform banking transactions via instances of the payment application 1718. For example, users can configure direct deposits or other deposits for adding assets to their various ledgers/balances. Further, users 1706 can configure bill pay, recurring payments, and/or the like using assets associated with their accounts. In addition to sending and/or receiving assets via peer-to-peer transactions, users 1706 buy and/or sell assets via asset networks such as cryptocurrency networks, securities networks, and/or the like.

FIG. 18 is an example of data store(s) that can be associated with servers of the payment service, according to an embodiment described herein. In at least one example, the data store(s) 1800 can store assets in an asset storage 1802, as well as data in user account(s) 1804, merchant account(s) 1806, and/or customer account(s) 1808. In at least one example, the asset storage 1802 can be used to store assets managed by the service provider of FIG. 17. In at least one example, the asset storage 1802 can be used to record whether individual of the assets are registered to users. For example, the asset storage 1802 can include an asset wallet 1810 for storing records of assets owned by the service provider of FIG. 17, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 1710 can be associated therewith. In some examples, the asset wallet 1810 can communication with the asset network via one or more components associated with the server(s) 1702.

The asset wallet 1810 can be associated with one or more addresses and can vary addresses used to acquire assets (e.g., from the asset network(s)) so that its holdings are represented under a variety of addresses on the asset network. In examples where the service provider of FIG. 17 has its own holdings of cryptocurrency (e.g., in the asset wallet 1810), a user can acquire cryptocurrency directly from the service provider of FIG. 17. In some examples, the service provider of FIG. 17 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1802 may contain ledgers that store records of assignments of assets to users 1706. Specifically, the asset storage 1802 may include asset ledger 1810, fiat currency ledger 1814, and other ledger(s) 1816, which can be used to record transfers of assets between users 1706 of the service provider and/or one or more third-parties (e.g., merchant network(s), payment card network(s), ACH network(s), equities network(s), the asset network, securities networks, etc.). In doing so, the asset storage 1802 can maintain a running balance of assets managed by the service provider of FIG. 17. The ledger(s) of the asset storage 1802 can further indicate some of the running balance for each of the ledger(s) stored in the asset storage 1802 is assigned or registered to one or more user account(s) 1804.

In at least one example, the asset storage 1802 can include transaction logs 1818, which can include records of past transactions involving the service provider of FIG. 17. In at least one example, transaction data, as described herein, can be stored in association with the transaction logs 1818.

In some examples, the data store(s) 1800 can store a private blockchain 1819. A private blockchain 1819 can function to record sender addresses, recipient addresses, public keys, values of cryptocurrency transferred, and/or can be used to verify ownership of cryptocurrency tokens to be transferred. In some examples, the service provider of FIG. 17 can record transactions taking place within the service provider of FIG. 17 involving cryptocurrency until the number of transactions has exceeded a determined limit (e.g., number of transactions, storage space allocation, etc.). Based at least in part on determining that the limit has been reached, the service provider of FIG. 17 can publish the transactions in the private blockchain 1819 to a public blockchain (e.g., associated with the asset network), where miners can verify the transactions and record the transactions to blocks on the public blockchain. In at least one example, the service provider of FIG. 17 can participate as miner(s) at least for its transactions to be posted to the public blockchain.

In at least one example, the data store(s) 1800 can store and/or manage accounts, such as user account(s) 1804, merchant account(s) 1806, and/or customer account(s) 1808. In at least one example, the user account(s) 1804 may store records of user accounts associated with the users 1706. In at least one example, the user account(s) 1804 can include a user account 1820, which can be associated with a user (of the users 1706). Other user accounts of the user account(s) 1804 can be similarly structured to the user account 1820, according to some examples. In other examples, other user accounts may include more or less data and/or account information than that provided by the user account 1820. In at least one example, the user account 1820 can include user account data 1828, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1828 can include account activity 1830 and user wallet key(s) 1832. The account activity 1830 may include a transaction log for recording transactions associated with the user account 1820. In some examples, the user wallet key(s) 1832 can include a public-private key-pair and a respective address associated with the asset network or other asset networks. In some examples, the user wallet key(s) 1832 may include one or more key pairs, which can be unique to the asset network or other asset networks.

In addition to the user account data 1828, the user account 1820 can include ledger(s) for account(s) managed by the service provider of FIG. 17, for the user. For example, the user account 1820 may include an asset ledger 1834, a fiat currency ledger 1836, and/or one or more other ledgers 1838. The ledger(s) can indicate that a corresponding user utilizes the service provider of FIG. 17 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 17.

In some examples, the asset ledger 1834 can store a balance for each of one or more cryptocurrencies (e.g., Bitcoin, Ethereum, Litecoin, etc.) registered to the user account 1820. In at least one example, the asset ledger 1834 can further record transactions of cryptocurrency assets associated with the user account 1820. For example, the user account 1820 can receive cryptocurrency from the asset network using the user wallet key(s) 1832. In some examples, the user wallet key(s) 1832 may be generated for the user upon request. User wallet key(s) 1832 can be requested by the user in order to send, exchange, or otherwise control the balance of cryptocurrency held by the service provider of FIG. 17 (e.g., in the asset wallet 1810) and registered to the user. In some examples, the user wallet key(s) 1832 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 17 and the value is credited as a balance in asset ledger 1834), by purchasing currency in the form associated with the account using currency in a different form (e.g., buying a value of cryptocurrency from the service provider of FIG. 17 using a value of fiat currency reflected in fiat currency ledger 1814, and crediting the value of cryptocurrency in asset ledger 1834), or by conducting a transaction with another user (customer or merchant) of the service provider of FIG. 17 wherein the account receives incoming currency (which can be in the form associated with the account or a different form, in which the incoming currency may be converted to the form associated with the account). In some examples, the user account data 1828 can include preferences for maintaining balances of individual of the ledgers. For example, the service provider of FIG. 17 can automatically debit the fiat currency ledger 1836 to increase the asset ledger 1834, or another account associated with the user whenever the cryptocurrency balance (e.g., of the asset ledger 1834) falls below a stated level (e.g., a threshold). Conversely, in some embodiments, the service provider of FIG. 17 can automatically credit the fiat currency ledger 1836 to decrease the asset ledger 1834 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s)) unrelated to the service provider of FIG. 17 (i.e., an external account). In at least one example, the user can transfer all or a portion of a balance of the cryptocurrency stored in the third-party cryptocurrency wallet to the service provider of FIG. 17. Such a transaction can require the user to transfer an amount of the cryptocurrency in a message signed by user's private key to an address provided by the service provider of FIG. 17. In at least one example, the transaction can be sent to miners to bundle the transaction into a block of transactions and to verify the authenticity of the transactions in the block. Once a miner has verified the block, the block is written to a public, distributed blockchain where the service provider of FIG. 17 can then verify that the transaction has been confirmed and can credit the user's asset ledger 1834 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 17. As described above, in some examples, the service provider of FIG. 17 can acquire cryptocurrency from a third-party source (e.g., associated with the third-party server(s) 118). In such examples, the asset wallet 1810 can be associated with different addresses and can vary addresses used to acquire cryptocurrency so that its holdings are represented under a variety of addresses on a blockchain. When the service provider of FIG. 17 has their own holdings of cryptocurrency, users can acquire cryptocurrency directly from the service provider of FIG. 17. In some examples, the service provider of FIG. 17 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 17 has its own cryptocurrency assets, cryptocurrency transferred in a transaction (e.g., data with address provided for receipt of transaction and a balance of cryptocurrency transferred in the transaction) can be stored in the asset wallet 1810. In at least one example, the service provider of FIG. 17 can credit the asset ledger 1834 of the user. Additionally, while the service provider of FIG. 17 recognizes that the user retains the value of the transferred cryptocurrency through crediting the asset ledger 1834, any person that inspects the blockchain will see the cryptocurrency as having been transferred to the service provider of FIG. 17. In some examples, the asset wallet 1810 can be associated with many different addresses. In such examples, any person that inspects the blockchain may not easily associate all cryptocurrency stored in asset wallet 1810 as belonging to the same entity. It is this presence of a private ledger that is used for real-time transactions and maintained by the service provider of FIG. 17, combined with updates to the public ledger at other times, that allows for extremely fast transactions using cryptocurrency to be achieved. In some examples, the “private ledger” can refer to the asset ledger 1810, which in some examples, can utilize the private blockchain 1819, as described herein. The “public ledger” can correspond to a public blockchain associated with the asset network.

In at least one example, a user's asset ledger 1834, fiat currency ledger 1836, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1834. In some examples, a user can receive fiat currency or another currency in the form of payment for a transaction with another user. In at least one example, at least a portion of such funds can be converted into cryptocurrency by the service provider of FIG. 17 and used to fund the asset ledger 1834 of the user.

As addressed above, in some examples, users can also have other accounts maintained by the service provider of FIG. 17. For example, a user can also have an account in U.S. dollars, which can be tracked, for example, via the fiat currency ledger 1836. Such an account can be funded by transferring money from a bank account at a third-party bank to an account maintained by the service provider of FIG. 17 as is conventionally known. In some examples, a user can receive fiat currency in the form of payment for a transaction with another user. In such examples, at least a portion of such funds can be used to fund the fiat currency ledger 1836.

In some examples, a user can have one or more internal payment cards registered with the service provider of FIG. 17. Internal payment cards can be linked to one or more of the accounts associated with the user account 1820. In some embodiments, options with respect to internal payment cards can be adjusted and managed using an application (e.g., the payment application 1718).

In at least one example, as described above, each ledger can correspond to an account of the user that is managed by the service provider of FIG. 17. In at least one example, individual of the accounts can be associated with a wallet or a stored balance for use in payment transactions, peer-to-peer transactions, payroll payments, etc.

In at least one example, the user account 1820 can be associated with an asset wallet 1840. The asset wallet 1840 of the user can be associated with account information that can be stored in the user account data 1828 and, in some examples, can be associated with the user wallet key(s) 1832. In at least one example, the asset wallet 1840 can store data indicating an address provided for receipt of a cryptocurrency transaction. In at least one example, the balance of the asset wallet 1840 can be based at least in part on a balance of the asset ledger 1834. In at least one example, funds availed via the asset wallet 1840 can be stored in the asset wallet 1840 or the asset wallet 1810. Funds availed via the asset wallet 1810 can be tracked via the asset ledger 1834. The asset wallet 1840, however, can be associated with additional cryptocurrency funds.

In at least one example, when the service provider of FIG. 17 includes a private blockchain 1819 for recording and validating cryptocurrency transactions, the asset wallet 1840 can be used instead of, or in addition to, the asset ledger 1834. For example, at least one example, a merchant can provide the address of the asset wallet 1840 for receiving payments. In an example where a customer is paying in cryptocurrency and the customer has their own cryptocurrency wallet account associated with the service provider of FIG. 17, the customer can send a message signed by its private key including its wallet address (i.e., of the customer) and identifying the cryptocurrency and value to be transferred to the merchant's asset wallet 1840. The service provider of FIG. 17 can complete the transaction by reducing the cryptocurrency balance in the customer's cryptocurrency wallet and increasing the cryptocurrency balance in the merchant's asset wallet 1840. In addition to recording the transaction in the respective cryptocurrency wallets, the transaction can be recorded in the private blockchain 1819 and the transaction can be confirmed. A user can perform a similar transaction with cryptocurrency in a peer-to-peer transaction as described above. In at least one example, the cryptocurrency wallet account 1830 can be funded by a balance transfer from a third-party cryptocurrency wallet, as described above. Such a transaction can require a user to transfer an amount of cryptocurrency in a message signed by the user's private key to an address of the cryptocurrency wallet account 1830. The transferred amount of cryptocurrency can then be within the cryptocurrency wallet account 1830 for use in later transactions.

While the asset ledger 1834 and/or asset wallet 1840 are each described above with reference to cryptocurrency, the asset ledger 1834 and/or asset wallet 1840 can alternatively be used in association with securities. In some examples, different ledgers and/or wallets can be used for different types of assets. That is, in some examples, a user can have multiple asset ledgers and/or asset wallets for tracking cryptocurrency, securities, or the like.

The data stores 1800 may also include a holding account 1842, which may be similar to and perform similar functions as the holding account 146 described with respect to FIG. 1.

It should be noted that user(s) having accounts managed by the service provider of FIG. 17 is an aspect of the technology disclosed that enables technical advantages of increased processing speed and improved security.

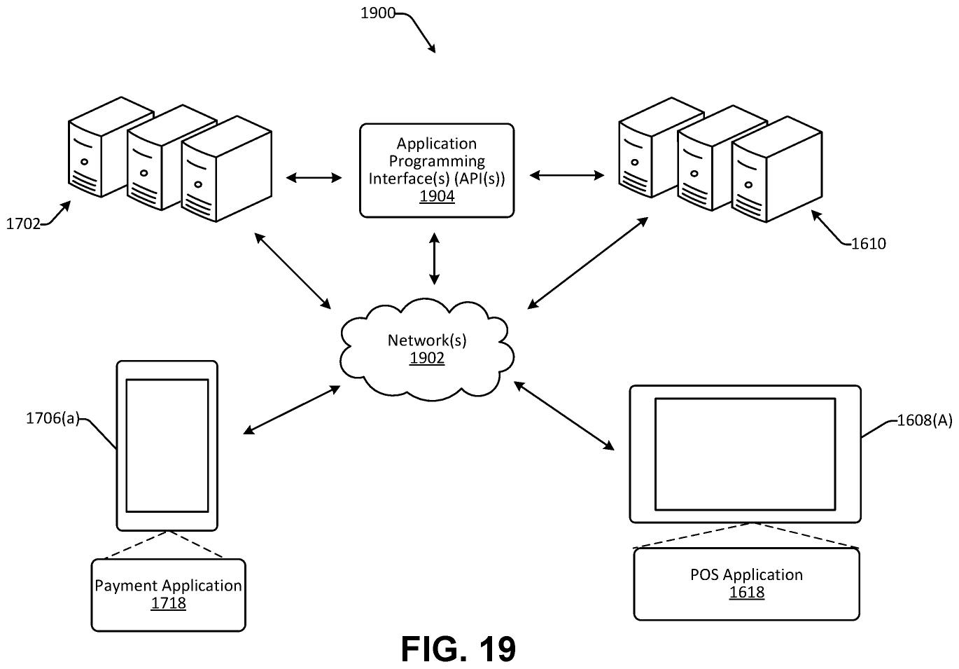

FIG. 19 is an example environment 1900 wherein the environment 1600 and the environment 1700 can be integrated to enable payments at the point-of-sale using assets associated with user accounts in the peer-to-peer environment of FIG. 17, according to an embodiment described herein. As illustrated, each of the components can communicate with one another via one or more networks 1902. In some examples, one or more APIs 1904 or other functional components can be used to facilitate such communication. For example, the APIs 1904 can be used to facilitate communication with payment service server(s) 1702 and server(s) 1710 associated with third-party service provider(s).

In at least one example, the example environment 1900 can enable contactless payments, via integration of peer-to-peer payment, or other payment making, platform(s) and payment processing platform(s), are described herein. For the purpose of FIG. 19, the environment 1600 can refer to a payment processing platform and the environment 1700 can refer to a peer-to-peer payment, or payment making, platform. In an example, such an integration can enable a customer to participate in a transaction via their own computing device instead of interacting with a merchant device of a merchant, such as the merchant device 1608(A). In such an example, the POS application 1618, associated with a payment processing platform and executable by the merchant device 1608(A) of the merchant, can present a Quick Response (QR) code, or other code that can be used to identify a transaction (e.g., a transaction code), in association with a transaction between the customer and the merchant. The QR code, or other transaction code, can be provided to the POS application 1618 via an API associated with the peer-to-peer payment platform. In an example, the customer can utilize their own computing device, such as the user device 1708(A), to capture the QR code, or the other transaction code, and to provide an indication of the captured QR code, or other transaction code, to server(s) 1602 and/or server(s) 1702.

Based at least in part on the integration of the peer-to-peer payment platform and the payment processing platform (e.g., via the API), the server(s) 1602 and/or 1702 associated with each can exchange communications with each other—and with a payment application 1718 associated with the peer-to-peer payment platform and/or the POS application 1618—to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QI code, or other transaction code, specific to the transaction can be used for providing transaction details, location details, customer details, or the like to a computing device of the customer, such as the user device 1708(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1708(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1618 and the payment application 1718, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 1708(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 1618, associated with a payment processing platform, on the merchant device 1608(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 1608(A) can present a QR code, or other transaction code, that can be associated with a peer-to-peer payment platform. The customer can use a camera associated with the user device 1708(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an APT) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 1618, associated with a payment processing platform, on the merchant device 1608(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 1618 can cause a text message with a resource locator (e.g., uniform resource locator (URL)) that can be associated with a peer-to-peer payment platform to be sent to the user device 1708(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 1708(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 1618 of a merchant device 1608(A) at a brick-and-mortar store of a merchant to a payment application 1718 of a user device 1708(A) of a customer to enable the customer to participate in a transaction via their own computing device. For instance, in a “scan to pay” example as described above, based at least in part on capturing the QR code, or other transaction code, via the user device 1708(A), the payment processing platform can provide transaction data to the peer-to-peer payment platform for presentation via the payment application 1718 on the user device 1708(A). In some examples, the customer can watch items being added to their cart (e.g., via a user interface presented via the payment application). As an item is added to a virtual cart by the merchant—via the POS application 1618 on the merchant device 1608(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 1718 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via, the user device 1708(A) during or after payment of the transaction.

In some examples, based at least in part on capturing the QR code, or other transaction code, the payment processing platform can provide transaction data to the peer-to-peer payment platform for presentation via the payment application 1718 on the computing device of the customer, such as the user device 1708(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 1718 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 1618, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1718 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

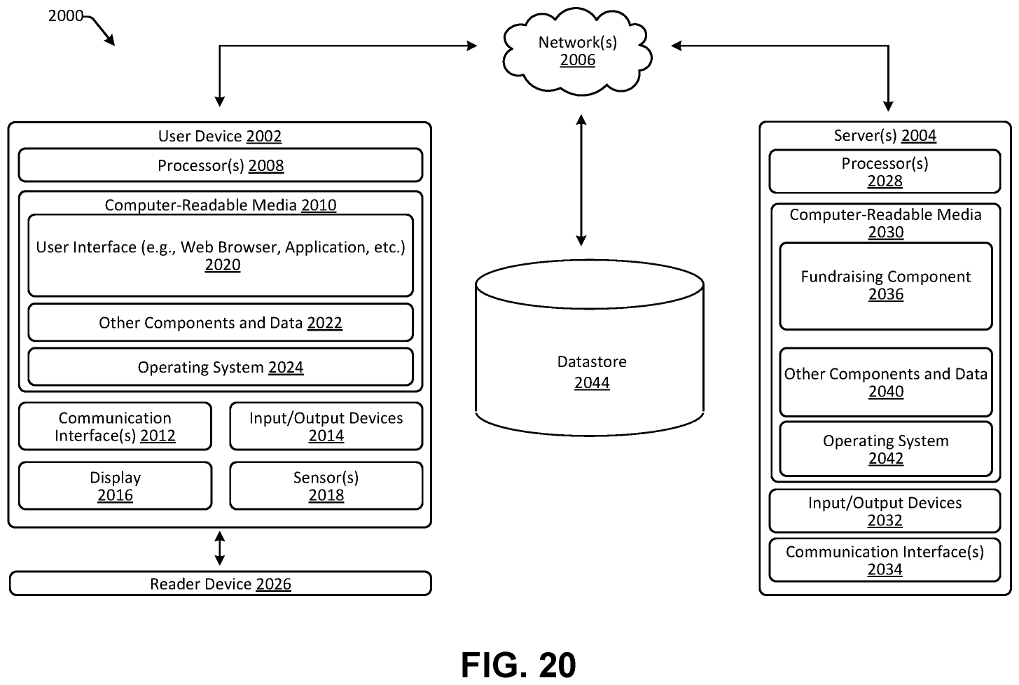

FIG. 20 is an illustrative block diagram illustrating a system for performing techniques described herein, according to an embodiment described herein. The system 2000 includes a user device 2002, that communicates with server computing device(s) (e.g., server(s) 2004) via network(s) 2006 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 2002 is illustrated, in additional or alternate examples, the system 2000 can have multiple user devices, as described above with reference to FIG. 20.

The user device 2002 may be the same or similar to the user device 102 as described with respect to FIG. 1. Additionally, the server(s) 2004 may be the same or similar to the payment service 104 described with respect to FIG. 1.

In at least one example, the user device 2002 can be any suitable type of computing device, e.g., portable, semi-portable, semi-stationary, or stationary. Some examples of the user device 2002 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 2002 can be any computing device capable of sending communications and performing the functions according to the techniques described herein. The user device 2002 can include devices, e.g., payment card readers, or components capable of accepting payments, as described below.

In the illustrated example, the user device 2002 includes one or more processors 2008, one or more computer-readable media 2010, one or more communication interface(s) 2012, one or more input/output (I/O) devices 2014, a display 2016, and sensor(s) 2018.

In at least one example, each processor 2008 can itself comprise one or more processors or processing cores. For example, the processor(s) 2008 can be implemented as one or more microprocessors, microcomputers, microcontrollers, digital signal processors, central processing units, state machines, logic circuitries, and/or any devices that manipulate signals based on operational instructions. In some examples, the processor(s) 2008 can be one or more hardware processors and/or logic circuits of any suitable type specifically programmed or configured to execute the algorithms and processes described herein. The processor(s) 2008 can be configured to fetch and execute computer-readable processor-executable instructions stored in the computer-readable media 2010.

Depending on the configuration of the user device 2002, the computer-readable media 2010 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 2010 can include, but is not limited to, RAM, ROM, EEPROM, flash memory, solid-state storage, magnetic disk storage, optical storage, and/or other computer-readable media technology. Further, in some examples, the user device 2002 can access external storage, such as RAID storage systems, storage arrays, network attached storage, storage area networks, cloud storage, or any other medium that can be used to store information and that can be accessed by the processor(s) 2008 directly or through another computing device or network. Accordingly, the computer-readable media 2010 can be computer storage media able to store instructions, components or components that can be executed by the processor(s) 2008. Further, when mentioned, non-transitory computer-readable media exclude media such as energy, carrier signals, electromagnetic waves, and signals per se.

The computer-readable media 2010 can be used to store and maintain any number of functional components that are executable by the processor(s) 2008. In some implementations, these functional components comprise instructions or programs that are executable by the processor(s) 2008 and that, when executed, implement operational logic for performing the actions and services attributed above to the user device 2002. Functional components stored in the computer-readable media 2010 can include a user interface 2020 to enable users to interact with the user device 2002, and thus the server(s) 2004 and/or other networked devices. In at least one example, the user interface 2020 can be presented via a web browser, or the like. In other examples, the user interface 2020 can be presented via an application, such as a mobile application or desktop application, which can be provided by a service provider associated with the server(s) 2004, or which can be an otherwise dedicated application. In some examples, the user interface 2020 can be configured to display options for withdrawing funds to make donations. The user interface 2020 may also be configured to surface information about donations. It should be understood that the user interface 2020 can be configured to display, facilitate, or otherwise perform any of the interactions described herein with respect to fundraising events or other operations as described herein. In at least one example, a user can interact with the user interface via touch input, spoken input, gesture, or any other type of input. The word “input” is also used to describe “contextual” input that may not be directly provided by the user via the user interface 2020. For example, user's interactions with the user interface 2020 are analyzed using, e.g., natural language processing techniques, to determine context or intent of the user, which may be treated in a manner similar to “direct” user input.

Depending on the type of the user device 2002, the computer-readable media 2010 can also optionally include other functional components and data, such as other components and data 2022, which can include programs, drivers, etc., and the data used or generated by the functional components. In addition, the computer-readable media 2010 can also store data, data structures and the like, that are used by the functional components. Further, the user device 2002 can include many other logical, programmatic and physical components, of which those described are merely examples that are related to the discussion herein.

In at least one example, the computer-readable media 2010 can include additional functional components, such as an operating system 2024 for controlling and managing various functions of the user device 2002 and for enabling basic user interactions.

The communication interface(s) 2012 can include one or more interfaces and hardware components for enabling communication with various other devices, such as over the network(s) 2006 or directly. For example, communication interface(s) 2012 can enable communication through one or more network(s) 2006, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 2006 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 2002 can further include one or more input/output (I/O) devices 2014. The I/O devices 2014 can include speakers, a microphone, a camera, and various user controls (e.g., buttons, a joystick, a keyboard, a keypad, etc.), a haptic output device, and so forth. The I/O devices 2014 can also include attachments that leverage the accessories (audio-jack, USB-C, Bluetooth, etc.) to connect with the user device 2002.

In at least one example, user device 2002 can include a display 2016. Depending on the type of computing device(s) used as the user device 2002, the display 2016 can employ any suitable display technology. For example, the display 2016 can be a liquid crystal display, a plasma display, a light emitting diode display, an OLED (organic light-emitting diode) display, an electronic paper display, or any other suitable type of display able to present digital content thereon. In at least one example, the display 2016 can be an augmented reality display, a virtually reality display, or any other display able to present and/or project digital content. In some examples, the display 2016 can have a touch sensor associated with the display 2016 to provide a touchscreen display configured to receive touch inputs for enabling interaction with a graphic interface presented on the display 2016. Accordingly, implementations herein are not limited to any particular display technology. Alternatively, in some examples, the user device 2002 may not include the display 2016, and information can be presented by other means, such as aurally, haptically, etc.

In addition, the user device 2002 can include sensor(s) 2018. The sensor(s) 2018 can include a GPS device able to indicate location information. Further, the sensor(s) 2018 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 2024, described above, to provide one or more services. That is, in some examples, the service provider 2024 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 2014 and/or for sending users 2014 notifications regarding available appointments with merchant(s) located proximate to the users 2014. In at least one example, location can be used for taking payments from nearby customers when they leave a geofence, or location can be used to initiate an action responsive to users 2014 enter a brick-and-mortar store of a merchant. Location can be used in additional or alternative ways as well.

Additionally, the user device 2002 can include various other components that are not shown, examples of which include removable storage, a power source, such as a battery and power control unit, a barcode scanner, a printer, a cash drawer, and so forth.

In addition, in some examples, the user device 2002 can include, be connectable to, or otherwise be coupled to a reader device 2026, for reading payment instruments and/or identifiers associated with payment objects. In some examples, as described above, the reader device 2026 can plug in to a port in the user device 2002, such as a microphone port, a headphone port, an audio-jack, a data port, or other suitable port. In additional or alternative examples, the reader device 2026 can be coupled to the user device 2002 via another wired or wireless connection, such as via a Bluetooth®, BLE, and so on. The reader device 2026 can include a read head for reading a magnetic strip of a payment card, and further can include encryption technology for encrypting the information read from the magnetic strip. Additionally or alternatively, the reader device 2026 can be an EMV payment reader, which in some examples, can be embedded in the user device 2002. Moreover, numerous other types of readers can be employed with the user device 2002 herein, depending on the type and configuration of the user device 2002.

The reader device 2026 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 2026 may include hardware implementation, such as slots, magnetic tracks, and rails with one or more sensors or electrical contacts to facilitate detection and acceptance of a payment instrument. That is, the reader device 2026 may include hardware implementations to enable the reader device 2026 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 2026 may also include a biometric sensor to receive and process biometric characteristics and process them as payment instruments, given that such biometric characteristics are registered with the payment service 104 and connected to a financial account with a bank server.

The reader device 2026 may include processing unit(s), computer-readable media, a reader chip, a transaction chip, a timer, a clock, a network interface, a power supply, and so on. The processing unit(s) of the reader device 2026 may execute one or more components and/or processes to cause the reader device 2026 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 2026, the computer-readable media may include volatile memory (such as RAM), non-volatile memory (such as ROM, flash memory, miniature hard drive, memory card, or the like), or some combination thereof. In at least one example, the computer-readable media of the reader device 2026 may include at least one component for performing various functions as described herein.

The reader chip may perform functionalities to control the operations and processing of the reader device 2026. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 2012, which may provide a clock signal indicating a time. Furthermore, the reader chip may perform functionality to control the network interface, which may interface with the network(s) 2006, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 2026. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 2002, which can be a POS terminal, and the reader device 2026 are shown as separate devices, in additional or alternative examples, the user device 2002 and the reader device 2026 can be part of a single device, which may be a battery-operated device. In such an example, components of both the user device 2002 and the reader device 2026 may be associated with the single device. In some examples, the reader device 2026 can have a display integrated therewith, which can be in addition to (or as an alternative of) the display 2016 associated with the user device 2002.

The server(s) 2004 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 2004 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 2004 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 2004 can include one or more processors 2028, one or more computer-readable media 2030, one or more I/O devices 2032, and one or more communication interfaces 2034. Each processor 2028 can be a single processing unit or a number of processing units, and can include single or multiple computing units or multiple processing cores. The processor(s) 2028 can be implemented as one or more microprocessors, microcomputers, microcontrollers, digital signal processors, central processing units, state machines, logic circuitries, and/or any devices that manipulate signals based on operational instructions. For example, the processor(s) 2028 can be one or more hardware processors and/or logic circuits of any suitable type specifically programmed or configured to execute the algorithms and processes described herein. The processor(s) 2028 can be configured to fetch and execute computer-readable instructions stored in the computer-readable media 2030, which can program the processor(s) 2028 to perform the functions described herein.

The computer-readable media 2030 can include volatile and nonvolatile memory and/or removable and non-removable media implemented in any type of technology for storage of information, such as computer-readable instructions, data structures, program components, or other data. Such computer-readable media 2030 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 2004, the computer-readable media 2030 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 2030 can be used to store any number of functional components that are executable by the processor(s) 2028. In many implementations, these functional components comprise instructions or programs that are executable by the processors 2028 and that, when executed, specifically configure the one or more processors 2028 to perform the actions attributed above to the service provider and/or payment processing service. Functional components stored in the computer-readable media 2030 can optionally include a fundraising component 2036 and one or more other components and data 2040. The fundraising component 2036 may be similar to the fundraising component 129 described with respect to FIG. 1 and may include some or all of the components described as a part of the fundraising component 129 from FIG. 1.

The other components may include a training component that can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 2002 and/or the server(s) 2004 for use at a time after the data models have been trained (e.g., at runtime).

The one or more other components and data 2040 can include programs, drivers, etc., and the data used or generated by the functional components. Further, the server(s) 2004 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 2030 can additionally include an operating system 2042 for controlling and managing various functions of the server(s) 2004.

The communication interface(s) 2034 can include one or more interfaces and hardware components for enabling communication with various other devices, such as over the network(s) 2006 or directly. For example, communication interface(s) 2034 can enable communication through one or more network(s) 2006, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 2002 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 2004 can further be equipped with various I/O devices 2032. Such I/O devices 2032 can include a display, various user interface controls (e.g., buttons, joystick, keyboard, mouse, touch screen, biometric or sensory input devices, etc.), audio speakers, connection ports and so forth.

In at least one example, the system 2000 can include a datastore 2044 that can be configured to store data that is accessible, manageable, and updatable. In some examples, the datastore 2044 can be integrated with the user device 2002 and/or the server(s) 2004. In other examples, as shown in FIG. 20, the datastore 2044 can be located remotely from the server(s) 2004 and can be accessible to the server(s) 2004. The datastore 2044 can comprise multiple databases and/or servers connected locally and/or remotely via the network(s) 2006.

In at least one example, the datastore 2044 can store user profiles, which can include merchant profiles, customer profiles, and so on. In some examples, the datastore(s) 2044 can store user profiles of donors, sponsors, organizers, beneficiaries, and other entities associated with a fundraising event, as described herein. In some examples, such user profiles can be associated with one or more user accounts.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 612.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the datastore 2044 can store inventory database(s) and/or catalog database(s). As described above, an inventory can store data associated with a quantity of each item that a merchant has available to the merchant. Furthermore, a catalog can store data associated with items that a merchant has available for acquisition. The datastore 2044 can store additional or alternative types of data as described herein.

Example Clauses

1. A computer-implemented method, comprising: generating, by at least one computing device associated with a payment service, an interactive element that has data embedded therein to trigger, in response to an interaction with the interactive element, a request to transfer funds from an account of a user to an account associated with a beneficiary of a fundraising event, wherein the interactive element is sharable via at least one of a text message, an email, a push notification, a user profile, or a forum; in response to the interaction with the interactive element, receiving, by the at least one computing device, the request to transfer funds from the account of the user to the account associated with the beneficiary of the fundraising event; identifying, by the at least one computing device and from context data associated with the request, a matching sponsor relevant to the request, the matching sponsor corresponding to an entity that will provide a matching donation when the user donates to the fundraising event; facilitating, by the at least one computing device and in response to receiving the request, a transfer of funds from the account of the user to a holding account of the payment service; facilitating, by the at least one computing device and in response to receiving the request, a transfer of additional funds from an account of the matching sponsor to the holding account of the payment service, wherein an amount of the additional funds is based on an amount of the funds transferred from the account of the user to the holding account of the payment service; and in response to determining that a condition associated with the fundraising event has been satisfied, transferring the funds of the user and the additional funds of the matching sponsor from the holding account to the account associated with the beneficiary of the fundraising event.

2. The computer-implemented method as clause 1 recites, further comprising: generating the context data based at least in part on at least one of: historical fundraiser data associated with a group of users, the group of users including the user; historical fundraiser data associated with the beneficiary; geographic data associated with the group of users; a user preference of the matching sponsor; a subject matter of the fundraising event; transaction data indicating transactions associated with the user performed utilizing the payment service; contacts data associated with the user; data representing social relationships of the user; a user preference associated with the user; and data indicating presence of a predefined metadata tag associated with the fundraiser event.

3. The computer-implemented method as clause 1 and/or 2 recites, wherein the matching sponsor comprises the payment service, another user, or a group of users.

4. The computer-implemented method as any of clauses 1, 2, and/or 3 recites, the operations further comprising: identifying the user based at least in part on analysis of at least one of transaction data associated with the user, contacts associated with the user, or one or more social graphs associated with the user; and sending, to the at least one computing device, message data that causes display of the interactive element.

5. A system comprising: one or more processors; and non-transitory computer-readable media storing instructions that, when executed by the one or more processors, cause the system to perform operations comprising: generating an interactive element with data embedded therein to trigger, in response to an interaction with the interactive element, a request to transfer funds from an account of a user to another account associated with a group of one or more users, wherein the interactive element is sharable; receiving, based at least in part on the interaction, the request to transfer funds from the account of the user to the other account associated with the group of one or more users; identifying, based at least in part on context data, at least one matching sponsor corresponding to an entity that will provide a matching transfer of funds when the user transfers funds from the account of the user to the other account; facilitating a transfer of funds from the account of the user to a holding account of a payment service; facilitating, based at least in part on identifying the at least one matching sponsor, a transfer of additional funds from an account of the at least one matching sponsor to the holding account of the payment service; and based at least in part on determining that a condition has been satisfied, transferring the funds of the user and the additional funds of the at least one matching sponsor from the holding account to the other account associated with the group of one or more users.

6. The system as clause 5 recites, the operations further comprising: generating the group of one or more users based at least in part on receiving indications that individual ones of the users have interacted with the interactive element; and associating user profiles of the users from the group of one or more users with the other account.

7. The system as clause 5 and/or 6 recites, the operations further comprising: determining the context data based at least in part on at least one of: historical data associated with the group of the one or more users; geographic data; one or more sponsor preferences; subject matter associated with the group; transaction data associated with the at least one matching sponsor; contacts data associated with the user; social relationship data; or metadata tag data.

8. The system as any of clauses 5, 6, and/or 7 recites, the operations further comprising: causing, on a device of the user, display of a confirmation that the at least one matching sponsor has transferred the additional funds, wherein the confirmation is selectable to display additional details of the transfer of the additional funds; receiving a selection of the confirmation; displaying the additional details of the transfer of the additional funds, the details including an option for the user to make an additional transfer of funds in association with a subsequent request to transfer funds to the other account; receiving a selection of the option; and facilitating a transfer of funds from the account of the user to the holding account based at least in part on receiving the subsequent request to transfer of funds into the other account.

9. The system as any of clauses 5, 6, 7, and/or 8 recites, the operations further comprising: identifying, based at least in part on the context data, at least one additional matching sponsor; and facilitating, based at least in part on identifying the at least one additional matching sponsor, a transfer of funds from an account of the at least one additional matching sponsor to the holding account.

10. The system as any of clauses 5, 6, 7, 8, and/or 9 recites, the operations further comprising: based at least in part on transferring the funds of the user and the additional funds of the matching sponsor from the holding account to the account associated with the other user, generating data representing an icon configured to be displayed in association with a user profile of the user, the icon indicating that the payment service has verified that at least one of (a) the user has transferred funds to the account of the other user or (b) the matching sponsor has transferred funds to the account of the other user; and causing display of the icon in association with the user profile.

11. The system as clause 10 recites, the operations further comprising: receiving user input data requesting that the icon be displayed in association with one or more social media platforms; and causing, utilizing one or more application programming interfaces (APIs) associated with the one or more social media platforms, the payment service to transmit a command to the one or more social media platforms, the command causing the icon to be displayed in association with another user profile of the user on the one or more social media platforms.

12. The system as any of clauses 5, 6, 7, 8, 9, 10, and/or 11 recites, wherein the other account is associated with a fundraising event, the transfer of funds is associated with a donation, and the matching transfer of funds is associated with a matching donation, the operations further comprising: receiving donations and matching donations over a period of time in association with the fundraising event; generating confirmation data indicating details of the donations and the matching donations, the details including at least one of a number of users that have donated, a number of the matching donations, an average donation amount, or a number of contacts associated with given users that donated; and causing display of the confirmation data in association with the fundraising event.

13. A computer-implemented method, implemented via one or more computing devices of a payment service, comprising: generating an interactive element with data embedded therein to trigger, in response to an interaction with the interactive element, a request to transfer funds from an account of a user to an account of a beneficiary of a fundraising event; receiving an indication that the interaction with the interactive element has occurred; identifying, based at least in part on context data, at least one matching sponsor corresponding to an entity that will provide a matching donation when the user donates to the fundraising event; and based at least in part on determining that a condition associated with the fundraising event has been satisfied: facilitating a transfer of funds from the account of the user to a holding account of the payment service or the account of the beneficiary; and facilitating a transfer of additional funds from an account of the matching sponsor to the holding account of the payment service or the account of the beneficiary.

14. The method as clause 13 recites, further comprising: determining attributes of the fundraising event; determining, from transaction data associated with users of the payment service, a group of users having prior transactions that are relevant to the attributes of the fundraising event; generating an actionable recommendation to participate in the fundraising event, the actionable recommendation including the interactive element; and sending the actionable recommendation to devices associated with the group of users.

15. The method as clause 13 and/or 14 recites, further comprising: receiving user input data requesting that the interactive element be shared with an additional user associated with the payment service; and causing data representing the interactive element to be sent in a message to a device associated with the additional user, the data causing the interactive element in the message to be displayed on the device of the additional user.

16. The method as any of clauses 13, 14, and/or 15 recites, further comprising: receiving user input data from a payment application executing on a device of the user requesting that the interactive element be shared with an additional user associated with the payment service, the payment application associated with the payment service; and causing data representing the interactive element to be sent to an instance of the payment application executing on a device of the additional user, the data causing the instance of the payment application to display the interactive element.

17. The method as any of clauses 13, 14, 15, and/or 16 recites, further comprising: importing information associated with the donation into a tax-based functionality associated with the payment service, the importing including formatting the information such that a tax-related document is configured to be generated that indicates the donation; and generating data representing the tax-related document based at least in part on the importing.

18. The method as any of clauses 13, 14, 15, 16, and/or 17 recites, further comprising: based at least in part on identifying the at least one matching sponsor, determining whether a match limit associated with the matching sponsor has been met; in response to determining that the match limit has not be met, performing the facilitating of the transfer of the additional funds from the account of the matching sponsor to the holding account of the payment service or the account of the beneficiary; and in response to determining that the match limit has been met, sending a request to proceed with the matching donation to a device associated with the matching sponsor, wherein performing the facilitating of the transfer of the additional funds is based at least in part on receiving a response to the request to proceed, the response confirming that the matching sponsor has permitted the transfer of the additional funds.

19. The method as any of clauses 13, 14, 15, 16, 17, and/or 18 recites, further comprising: determining the context data based at least in part on at least one of: historical data associated with a group of users; geographic data; one or more sponsor preferences; subject matter associated with the group; transaction data associated with at least one matching sponsor; contacts data associated with the user; social relationship data; or metadata tag data.

20. The method as any of clauses 13, 14, 15, 16, 17, 18, and/or 19 recites, further comprising: generating a metadata tag for the fundraising event, the metadata tag configured to enable a page associated with the fundraising event to be displayed by selection of the metadata tag; and associating the metadata tag with the fundraising event; detecting use of the metadata tag in at least one of a payment application associated with the payment service or another application; and based at least in part on detecting the use of the metadata tag, causing the interactive element to be displayed.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to FIGS. 11-15 for convenience and ease of understanding. However, the methods illustrated are not limited to being performed using components described in FIGS. 1-10 and 16-20, and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

The foregoing is merely illustrative of the principles of this disclosure and various modifications can be made by those skilled in the art without departing from the scope of this disclosure. The above described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

1. A computer-implemented method, comprising:
generating, by at least one computing device associated with a payment service, an interactive element that has data embedded therein to trigger, in response to an interaction with the interactive element as rendered on a user interface, a request to transfer funds from an account of a user to an account associated with a beneficiary of a fundraising event, wherein the interactive element is sharable by the user to one or more potential donors across multiple platforms via at least one of a text message, an email, a push notification, a user profile, or a forum and, when selected, links to a resource locator associated with the fundraising event;
in response to the interaction with the interactive element, receiving, by the at least one computing device, the request to transfer funds from the account of the user to the account associated with the beneficiary of the fundraising event;
identifying, by the at least one computing device and from context data associated with the request, a matching sponsor relevant to the request and differing from the beneficiary, the matching sponsor corresponding to an entity that will provide a matching donation when the user donates to the fundraising event, wherein identifying the matching sponsor is performed responsive to receiving the request and prior to a transfer of funds from the account of the user;
facilitating, by the at least one computing device and in response to receiving the request, the transfer of funds from the account of the user to a holding account of the payment service;
facilitating, by the at least one computing device and in response to receiving the request, a transfer of additional funds from an account of the matching sponsor to the holding account of the payment service, wherein an amount of the additional funds is based on an amount of the funds transferred from the account of the user to the holding account of the payment service; and
in response to determining that a condition associated with the fundraising event has been satisfied, transferring the funds of the user and the additional funds of the matching sponsor from the holding account to the account associated with the beneficiary of the fundraising event.

2. The computer-implemented method as claim 1 recites, further comprising:
generating the context data based at least in part on at least one of:
historical fundraiser data associated with a group of users, the group of users including the user;
historical fundraiser data associated with the beneficiary;
geographic data associated with the group of users;
a user preference of the matching sponsor;
a subject matter of the fundraising event;
transaction data indicating transactions associated with the user performed utilizing the payment service;
contacts data associated with the user;
data representing social relationships of the user;
a user preference associated with the user; and
data indicating presence of a predefined metadata tag associated with the fundraiser event.

3. The computer-implemented method as claim 1 recites, wherein the matching sponsor comprises the payment service, another user, or a group of users.

4. The computer-implemented method as claim 1 recites, the operations further comprising:
identifying the user based at least in part on analysis of at least one of transaction data associated with the user, contacts associated with the user, or one or more social graphs associated with the user; and
sending, to the at least one computing device, message data that causes display of the interactive element.

5. A system comprising:
one or more processors; and
non-transitory computer-readable media storing instructions that, when executed by the one or more processors, cause the system to perform operations comprising:
generating an interactive element with data embedded therein to trigger, in response to an interaction with the interactive element as rendered on a user interface, a request to transfer funds from an account of a user to another account associated with a group of one or more users, wherein the interactive element is sharable to one or more potential donors across multiple platforms and, when selected, links to a resource locator associated with the request;
receiving, based at least in part on the interaction, the request to transfer funds from the account of the user to the other account associated with the group of one or more users;
identifying, based at least in part on context data, at least one matching sponsor, differing from the user, corresponding to an entity that will provide a matching transfer of funds when the user transfers funds from the account of the user to the other account, wherein identifying the at least one matching sponsor is performed responsive to receiving the request and prior to a transfer of funds from the account of the user;
facilitating transfer of funds from the account of the user to a holding account of a payment service;
facilitating, based at least in part on identifying the at least one matching sponsor, a transfer of additional funds from an account of the at least one matching sponsor to the holding account of the payment service; and
based at least in part on determining that a condition has been satisfied, transferring the funds of the user and the additional funds of the at least one matching sponsor from the holding account to the other account associated with the group of one or more users.

6. The system as claim 5 recites, the operations further comprising:
generating the group of one or more users based at least in part on receiving indications that individual ones of the users have interacted with the interactive element; and
associating user profiles of the users from the group of one or more users with the other account.

7. The system as claim 5 recites, the operations further comprising:
determining the context data based at least in part on at least one of:
historical data associated with the group of the one or more users;
geographic data;
one or more sponsor preferences;
subject matter associated with the group;
transaction data associated with the at least one matching sponsor;
contacts data associated with the user;
social relationship data; or
metadata tag data.

8. The system as claim 5 recites, the operations further comprising:
causing, on a device of the user, display of a confirmation that the at least one matching sponsor has transferred the additional funds, wherein the confirmation is selectable to display additional details of the transfer of the additional funds;
receiving a selection of the confirmation;
displaying the additional details of the transfer of the additional funds, the details including an option for the user to make an additional transfer of funds in association with a subsequent request to transfer funds to the other account;
receiving a selection of the option; and
facilitating a transfer of funds from the account of the user to the holding account based at least in part on receiving the subsequent request to transfer of funds into the other account.

9. The system as claim 5 recites, the operations further comprising:
identifying, based at least in part on the context data, at least one additional matching sponsor; and
facilitating, based at least in part on identifying the at least one additional matching sponsor, a transfer of funds from an account of the at least one additional matching sponsor to the holding account.

10. The system as claim 5 recites, the operations further comprising:
based at least in part on transferring the funds of the user and the additional funds of the matching sponsor from the holding account to the account associated with the other user, generating data representing an icon configured to be displayed in association with a user profile of the user, the icon indicating that the payment service has verified that at least one of (a) the user has transferred funds to the account of the other user or (b) the matching sponsor has transferred funds to the account of the other user; and
causing display of the icon in association with the user profile.

11. The system as claim 10 recites, the operations further comprising:
receiving user input data requesting that the icon be displayed in association with one or more social media platforms, the one or more social media platforms representing a subset of the multiple platforms; and
causing, utilizing one or more application programming interfaces (APIs) associated with the one or more social media platforms, the payment service to transmit a command to the one or more social media platforms, the command causing the icon to be displayed in association with another user profile of the user on the one or more social media platforms.

12. The system as claim 5 recites, wherein the other account is associated with a fundraising event, the transfer of funds is associated with a donation, and the matching transfer of funds is associated with a matching donation, the operations further comprising:
receiving donations and matching donations over a period of time in association with the fundraising event;
generating confirmation data indicating details of the donations and the matching donations, the details including at least one of a number of users that have donated, a number of the matching donations, an average donation amount, or a number of contacts associated with given users that donated; and
causing display of the confirmation data in association with the fundraising event.

13. A computer-implemented method, implemented via one or more computing devices of a payment service, comprising:
generating an interactive element with data embedded therein to trigger, in response to an interaction with the interactive element rendered on a graphical user interface, a request to transfer funds from an account of a user to an account of a beneficiary of a fundraising event, wherein the interactive element is sharable to one or more potential donors across multiple platforms and, when selected, links to a resource locator associated with the request;
receiving an indication that the interaction with the interactive element has occurred;
identifying, based at least in part on context data, at least one matching sponsor that differs from the beneficiary and corresponds to an entity that will provide a matching donation when the user donates to the fundraising event, wherein identifying the at least one matching sponsor is performed responsive to receiving the request and prior to a transfer of funds from the account of the user; and
based at least in part on determining that a condition associated with the fundraising event has been satisfied:
facilitating the transfer of funds from the account of the user to a holding account of the payment service or the account of the beneficiary; and
facilitating a transfer of additional funds from an account of the at least one matching sponsor to the holding account of the payment service or the account of the beneficiary.

14. The computer-implemented method as claim 13 recites, further comprising:
determining attributes of the fundraising event;
determining, from transaction data associated with users of the payment service, a group of users having prior transactions that are relevant to the attributes of the fundraising event;
generating an actionable recommendation to participate in the fundraising event, the actionable recommendation including the interactive element; and
sending the actionable recommendation to devices associated with the group of users.

15. The computer-implemented method as claim 13 recites, further comprising:
receiving user input data requesting that the interactive element be shared with an additional user associated with the payment service; and
causing data representing the interactive element to be sent in a message to a device associated with the additional user, the data causing the interactive element in the message to be displayed on the device of the additional user.

16. The computer-implemented method as claim 13 recites, further comprising:
receiving user input data from a payment application executing on a device of the user requesting that the interactive element be shared with an additional user associated with the payment service, the payment application associated with the payment service; and
causing data representing the interactive element to be sent to an instance of the payment application executing on a device of the additional user, the data causing the instance of the payment application to display the interactive element.

17. The computer-implemented method as claim 13 recites, further comprising:
importing information associated with the donation into a tax-based functionality associated with the payment service, the importing including formatting the information such that a tax-related document is configured to be generated that indicates the donation; and
generating data representing the tax-related document based at least in part on the importing.

18. The computer-implemented method as claim 13 recites, further comprising:
based at least in part on identifying the at least one matching sponsor, determining whether a match limit associated with the matching sponsor has been met;
in response to determining that the match limit has not be met, performing the facilitating of the transfer of the additional funds from the account of the matching sponsor to the holding account of the payment service or the account of the beneficiary; and
in response to determining that the match limit has been met, sending a request to proceed with the matching donation to a device associated with the matching sponsor, wherein performing the facilitating of the transfer of the additional funds is based at least in part on receiving a response to the request to proceed, the response confirming that the matching sponsor has permitted the transfer of the additional funds.

19. The computer-implemented method as claim 13 recites, further comprising:
determining the context data based at least in part on at least one of:
historical data associated with a group of users;
geographic data;
one or more sponsor preferences;
subject matter associated with the group;
transaction data associated with at least one matching sponsor;
contacts data associated with the user;
social relationship data; or
metadata tag data.

20. The computer-implemented method as claim 13 recites, further comprising:
generating a metadata tag for the fundraising event, the metadata tag configured to enable a page associated with the fundraising event to be displayed by selection of the metadata tag; and
associating the metadata tag with the fundraising event;
detecting use of the metadata tag in at least one of a payment application associated with the payment service or another application; and
based at least in part on detecting the use of the metadata tag, causing the interactive element to be displayed.
